(19) United States
(12) Patent Application Publication
(10) Pub. No.: US 2008/0270513 A1
(43) Pub. Date: Oct. 30, 2008

(54) DATA TRANSMITTING APPARATUS, DATA RECEIVING APPARATUS, AND DATA TRANSMITTING AND RECEIVING SYSTEM

(76) Inventors: Kazunari FUJIWARA, Osaka (JP); Yasushi Ayaki, Osaka (JP); Takuya Nishimura, Osaka (JP); Kenichi Shibata, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/108,802

(22) Filed: Apr. 24, 2008

(30) Foreign Application Priority Data
Apr. 27, 2007 (JP) 2007-120304

(51) Int. Cl. G06F 15/16

(52) U.S. Cl. 709/201

(57) ABSTRACT

A data transmitting apparatus that transmits content data having use restriction is provided. The data transmitting apparatus includes: a data transmitting unit that transmits the content data to the first data receiving apparatus that receives the content data for viewing, and transmits the content data to the second data receiving apparatus that receives the content data so that the content data is transferred; a calculation unit that calculates a time required for the data transmitting unit to complete transmitting the content data to the first or second data receiving apparatus; and a notification unit that notifies the first or second data receiving apparatus of the time calculated by the calculation unit. The first or second data receiving apparatus that receives the notification is the data receiving apparatus that is not the data receiving apparatus corresponding to the time.

### BACKGROUND OF THE INVENTION

(1) Field of the Invention

The present invention relates to data transmitting apparatuses, data receiving apparatuses, and data transmitting and receiving systems. The invention particularly relates to a technique for transferring data between two devices via a network.

(2) Description of the Related Art

In recent years, owing to the development of broadband environments including xDigital Subscriber Lines (hereinafter abbreviated as xDSL) and optical fibers, high-speed Internet accesses have become common from businesses to households. Further, home network environments have also become popular, in which personal computers (hereinafter abbreviated as PC) and digital home appliances in a household are connected via Ethernet®, wireless LAN, or the like.

Accordingly, it is desired that a variety of applications can be executed between digital home appliances or between digital home appliances and PCs in the Internet access environment and the home network environment. The variety of applications includes for example: an application that transfers video and audio data stored in a Digital Versatile Disc (hereinafter abbreviated as DVD) recorder (hereinafter referred to as content data) to a PC for viewing or editing; an application that transfers (dubbing) content data stored in a DVD recorder to another DVD recorder; and so on. With such applications, a user can use data freely, paying little attention to a location of the content data.

Further, the applications that are executed between digital home appliances or between digital home appliances and PCs in the Internet access environment and the home network environment can be implemented by a file transfer technique which is a technique for transmitting or transferring content data and so on.

In the case where the content data to be used is on the network and requires a copyright protection, it is necessary to protect the content data by encrypting the content data. Digital Transmission Content Protection over IP (hereinafter referred to as DTCP-IP) is a currently available technique for preventing unauthorized copy that is carried out by using data transferring on the network.

In the DTCP-IP, the following are defined as copy control information for content data: (i) Copy Never; that is, a copying is totally prohibited; (ii) Copy One Generation; that is, a copying is allowed for only a single generation (this information is changed to Copy No More subsequent to the copying); and (iii) Copy Free; that is, a copying can be performed freely. Details of the DTCP-IP specification are disclosed by: Non patent reference 1: Digital Transmission Content Protection Specification Volume 1 (Informational Version); Non patent reference 2: Digital Transmission Protection License Agreement; Non patent reference 3: DTCP Volume 1 Supplement E Mapping DTCP to IP; and Non patent reference 4: RFC2616 Hypertext Transfer Protocol—HTTP/1.1.

In the DTCP-IP, a file transferring technique has been under consideration, which allows recorded content data of Copy One Generation to be transferred to another apparatus so that a user can use data freely, not having to know where the content data that requires a copyright protection is located.

In the file transferring technique, a data transmitting apparatus that is a source of data transferring deletes or invalidates transferred data immediately after the data has been transferred. More specifically, it is allowed that the data transmitting apparatus transfers copied data of Copy One Generation to another apparatus under the condition that more than one usable data may not be present (hereinafter referred to as MOVE). In other words, data needs to be transmitted or transferred such that usable data is not present in both of the data transmitting apparatus and the data receiving apparatus at the same time in order to implement MOVE while observing the condition that more than one usable data may not be present.

A method for implementing MOVE of data of Copy One Generation while observing the condition that more than one usable data may not be present has been under consideration. A method for implementing secure MOVE (transferring) of content data has been under consideration, for example, by which a data transmitting apparatus encrypts data, outputs the encrypted data to a data receiving apparatus, and transmits a confirmation notification command after the output of the entire content has been completed.

With the method currently under consideration, however, the data receiving apparatus transmits, to the data transmitting apparatus, the confirmation notification command which indicates the completion of receiving the content data which has been subjected to MOVE processing from the data transmitting apparatus. The data transmitting apparatus deletes the content data in the data transmitting apparatus when the confirmation notification command from the data receiving apparatus is received. Accordingly, there is a problem that, in the case where the data transmitting apparatus receives the confirmation notification command from the data receiving apparatus while a user is viewing content data stored in the data transmitting apparatus using another data receiving apparatus, the content data stored in the data transmitting apparatus is deleted and the user can not continue the viewing.

### SUMMARY OF THE INVENTION

Accordingly, the present invention has been conceived in view of the above-described problem and aims to provide a data transmitting apparatus, a data receiving apparatus, and a data transmitting and receiving system, which can prevent an abrupt halt on viewing of content data stored in the data transmitting apparatus while the data receiving apparatus is reproducing the content data for viewing.

In order to achieve the object described above, a data transmitting apparatus according to the present invention which transmits content data having use restriction includes: a transmitting unit which transmits the content data to a first data receiving apparatus that receives the content data for viewing and transmits the content data to a second data receiving apparatus so that the content data is transferred; a calculation unit which calculates a time required for the data transmitting unit to complete transmitting the content data to one of the first data receiving apparatus and the second data receiving apparatus; and a notification unit which notifies one of the first data receiving apparatus and the second data receiving apparatus of the time calculated by the calculation unit, the one of the first data receiving apparatus and the second data receiving apparatus being a data receiving apparatus not corresponding to the time.

This structure makes it possible to calculate a time required for the first data receiving apparatus to complete reproduction for viewing and to notify the second data receiving apparatus of the calculated time, thereby enabling, for example, an adjustment of a time for transmitting content to the second data receiving apparatus. Further, it is possible to calculate a time required for completing transmission of content data to the second data receiving apparatus, and to notify of a time for transmitting content to the first data receiving apparatus. With this, it is possible to implement the data transmitting apparatus which can prevent an abrupt halt on viewing of content data stored in the data transmitting apparatus while the data receiving apparatus is reproducing the content data for viewing.

The data transmitting apparatus may further include a control unit which changes a state of the content data between a usable state and an unusable state and, in the data transmitting apparatus, the calculation unit may calculate the time required for completing the transmission of the content data to the first data receiving apparatus, the notification unit may notify the second data receiving apparatus of the time and cause the second data receiving apparatus to transmit, to the data transmitting apparatus, completion-notifying information indicating that the second data receiving apparatus has completed receiving the content data, after the content data has been received and the time has passed, and the control unit may change the state of the content data in the data transmitting apparatus to the unusable state after the completion-notifying information has been received. This structure makes it possible to calculate the time required for the first data receiving apparatus to complete reproduction for viewing and to notify the second data receiving apparatus of the calculated time, thereby enabling an adjustment of the content data in the data transmitting apparatus so as not to be unusable until the first data receiving apparatus completes the reproduction for viewing.

The data transmitting apparatus may further include a reproduction unit which reproduces the content data and, in the data transmitting apparatus, the calculation unit may calculate a reproduction time required for the reproduction unit to complete reproduction of the content data, the notification unit may notify the reproduction unit of the time in the case where the time is shorter than the reproduction time, and the reproduction unit may indicate information on the time which has been notified by the notification unit.

This structure makes it possible to notify the time when viewing of content data is halted, even in the case where the data transmitting apparatus reproduces the content. With this, it is possible to prevent an abrupt halt on viewing of content data stored in the data transmitting apparatus.

The reproduction unit may, in the case where the time is notified by the notification unit, reproduce the content data at high speed so as to complete reproduction of the content data within the time.

This structure makes it possible to overview the details of content data with high-speed reproduction before the time when viewing of content data is halted. With this, it is possible to prevent an abrupt halt on viewing of content data stored in the data transmitting apparatus.

The calculation unit may calculate the time required for completing transmission of the content data to the second data receiving apparatus. The notification unit may notify the first data receiving apparatus of the time and cause the first data receiving apparatus to indicate information on the time.

This structure makes it possible to calculate the time required for completing transmission, to the second data receiving apparatus, of the content data having use restriction and to notify of the time when reproduction for viewing of content data by the first data receiving apparatus is halted due to completion of transmitting the content data to the second data receiving apparatus. With this, it is possible to prevent an abrupt halt on viewing of content data stored in the data transmitting apparatus while the data receiving apparatus is reproducing for viewing the content data.

The data transmitting apparatus may further include: a control unit which may change a state of the content data between a usable state and an unusable state; and a selection unit which may select, according to a specification by a user of the data transmitting apparatus, whether the time calculated by the calculation unit is a first time for the first data receiving apparatus or a second time for the second data receiving apparatus and, in the data transmitting apparatus, in the case where the first time is selected by the selection unit: the notification unit may notify the second data receiving apparatus of the first time and cause the second data receiving apparatus to transmit, to the data transmitting apparatus, completion-notifying information indicating that the second data receiving apparatus has completed receiving the content data, after the content data has been received and the first time has passed; and the control unit may change the state of the content data in the data transmitting apparatus to the unusable state, after the completion-notifying information has been transmitted, and, in the case where the second time is selected by the selection unit, the notification unit may notify the first data receiving apparatus of the second time and cause the first data receiving apparatus to indicate information on the second time.

This structure makes it possible to select, according to a user's choice, between the reproduction for viewing by the first data receiving apparatus and the transmission of content data from the data transmitting apparatus to the second data receiving apparatus, for putting more priority. Accordingly, it is possible for the user to select a way to prevent an abrupt halt on viewing of content data stored in the data transmitting apparatus while the data receiving apparatus is reproducing for viewing the content data.

The transmitting unit may transmit content data having use restriction under a copyright protection technology specification defined in the Digital Transmission Content Protection over IP (DTCP-IP).

This structure makes it possible, when the content data to be used is on the network and requires a copyright protection, to implement a data transmitting apparatus with excellent versatility under the DTCP-IP specification.

In the data transmitting apparatus, notification of the time and the completion-notifying information may be performed by using a MV_FINALIZE command that is one of commands of the copyright protection technology specification defined in the DTCP-IP, and the notification unit may notify the time by replacing the time with a random number value which is one of parameters in the MV_FINALIZE command.

This structure makes it possible to use commands defined in the DTCP-IP, thereby enabling implementation of a data transmitting apparatus with excellent versatility and usability.

The control unit may change the state of the content data to the unusable state by deleting the content data. With this structure, there is no need to hold unusable content data, thereby enabling implementation of a data transmitting apparatus, with excellent usability, having no need to have capacity for unnecessary storage.

Further, in order to achieve the object described above, a data receiving apparatus according to the present invention, which receives, from a data transmitting apparatus, content data having use restriction so that the content data is transferred, may includes: a data receiving unit which may receive the content data; a time notification receiving unit which may receive, from the data transmitting apparatus, a time required for the data transmitting apparatus to complete transmitting the content data to another data receiving apparatus; a completion notification transmitting unit which may transmit, to the data transmitting apparatus, completion-notifying information indicating that the data receiving unit has completed receiving the content data; and a control unit which may control the completion notification transmitting unit to transmit the completion-notifying information to the data transmitting apparatus after the content data has been received and the time has passed.

With this structure, it is possible for the data receiving apparatus to delay the completion notification until another data receiving apparatus completes reproduction of content having use restriction. With this, it is possible to implement the data receiving apparatus which can prevent an abrupt halt on viewing of content data stored in the data transmitting apparatus while the data receiving apparatus is reproducing the content data for viewing.

Further, in order to achieve the object described above, a data receiving apparatus according to the present invention, which receives, for viewing, content data having use restriction from a data transmitting apparatus, includes: a data receiving unit which may receive the content data; a time notification receiving unit which may receive, from the data transmitting apparatus, a time required for the data transmitting apparatus to complete transmitting the content data to another data receiving apparatus; and an information indicating unit which may indicate information on the time.

This structure makes it possible for the data receiving apparatus to indicate information on the time such as information indicating that viewing cannot continue, by receiving the time in advance. With this, it is possible to implement the data receiving apparatus which can prevent an abrupt halt on viewing of content data stored in the data transmitting apparatus while the data receiving apparatus is reproducing the content data for viewing.

The data receiving apparatus may further include a reproduction speed calculating unit which may calculate a reproduction speed at which the content data is reproduced according to the time, and the data receiving apparatus may reproduce the content data at the reproduction speed by causing the data receiving unit to receive the content data in a receiving scheme changed so as to suit the reproduction speed calculated by the reproduction speed calculating unit.

This structure makes it possible to overview the details of content data with high-speed reproduction before the time when viewing of content data is halted. With this, it is possible to prevent an abrupt halt on viewing of content data stored in the data transmitting apparatus.

Further, in order to achieve the object described above, a data transmitting and receiving system according to the present invention in which content data having use restriction is transmitted and received may include: a data transmitting apparatus; a first data receiving apparatus; and a second data receiving apparatus and, in the data transmitting and receiving system, the data transmitting apparatus may include: a transmitting unit which may transmit the content data to a first data receiving apparatus that receives the content data for viewing and may transmit the content data to a second data receiving apparatus so that the content data is transferred; a calculation unit which may calculate a time required for the transmitting unit to complete transmitting the content data to the second data receiving apparatus; a notification unit which may notify the first data receiving apparatus of the time calculated by the calculation unit, the first data receiving apparatus being a data receiving apparatus that is not the second data receiving apparatus corresponding to the time; and a control unit which may change a state of the content data in the data transmitting apparatus between a usable state and an unusable state and, the first data receiving apparatus that receives content data for viewing may include: a first data receiving unit which may receive the content data; a time notification receiving unit which may receive the time notified by the data transmitting apparatus; a indicating unit which may indicate information on the time, and a reproduction speed calculating unit which may calculate a reproduction speed at which the content data is reproduced according to the time and, in the first data receiving apparatus, the data receiving apparatus may reproduce the content data at the reproduction speed by causing the data receiving unit to receive the content data in a receiving scheme changed so as to suit the reproduction speed calculated by the reproduction speed calculating unit and, the second data receiving apparatus that receives content data so that the content data is transferred may include: a second data receiving unit which may receive the content data; and a completion notification transmitting unit which may transmit, to the data transmitting apparatus, completion-notifying information indicating that the second data receiving unit has completed receiving the content data and, in the data transmitting apparatus, the control unit may change the state of the content data in the data transmitting apparatus to the unusable state after the completion-notifying information has been received.

Further, in order to achieve the object described above, a data receiving method according to the present invention, used by a data receiving apparatus which receives, from a data transmitting apparatus, content data having use restriction for viewing includes: receiving the content data; receiving a time from the data transmitting apparatus, the time being required for the data transmitting apparatus to complete transmitting the content data to another data receiving apparatus; calculating a reproduction speed at which the content data is reproduced according to the time, and indicating information on the time and, in the receiving of the content data, the content data is received in a receiving scheme changed so as to suit the reproduction speed calculated in the calculating of the reproduction speed, so that the content data is reproduced at the reproduction speed.

Further, in order to achieve the object described above, a data receiving program product for a data receiving apparatus which receives, from a data transmitting apparatus, content data having use restriction for viewing, the data receiving program product, when loaded into a computer, allowing a computer to execute: receiving the content data; receiving a time from the data transmitting apparatus, the time being required for the data transmitting apparatus to complete transmitting the content data to another data receiving apparatus; calculating a reproduction speed at which the content data is reproduced according to the time; and indicating information on the time and, in the receiving of the content data, the content data is received in a receiving scheme changed so as to suit the reproduction speed calculated in the calculating of the reproduction speed, so that the content data is reproduced at the reproduction speed.

Note that the present invention can be implemented not only as an apparatus but also as an integrated circuit including processing units that the apparatus includes, as a method including processing units included in the apparatus as steps, as a program which, when loaded into a computer, allows a computer to execute the steps, and information, data and a signal which represent the program. Further, the program, the information, the data and the signal may be distributed via recording medium such as a CD-ROM and communication medium such as the Internet.

The present invention makes it possible to implement the data transmitting apparatus, the data receiving apparatus, and the data transmitting and receiving system which can prevent an abrupt halt on viewing of content data stored in the data transmitting apparatus while the data receiving apparatus is reproducing the content data for viewing. Accordingly, the practical value of the present invention is high in the present day as the Internet access environment and the home network environment each of which connects between digital home appliances or between digital home appliances and PCs are becoming popular.

### FURTHER INFORMATION ABOUT TECHNICAL BACKGROUND TO THIS APPLICATION

The disclosure of Japanese Patent Application No. 2007-120304 filed on Apr. 27, 2007 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a schematic view illustrating a data transmitting and receiving system in a network environment according to the first embodiment of the present invention;

FIG. 2 conceptually illustrates a process of recording content data of Copy One Generation according to the first embodiment of the present invention;

FIG. 3 conceptually illustrates a process of transferring content data of Copy One Generation according to the first embodiment of the present invention;

FIG. 4 is a sequence diagram between a data transmitting apparatus and a data receiving apparatus during MOVE processing defined in the DTCP-IP;

FIGS. 5A and 5B conceptually illustrate the details of a MV_FINALIZE command defined in the DTCP-IP;

FIGS. 6A and 6B conceptually illustrate the details of a MV_COMPLETE command defined in the DTCP-IP;

FIG. 7 is a block diagram illustrating a configuration of the data transmitting apparatus according to the first embodiment of the present invention;

FIG. 8 is a block diagram illustrating a configuration of the data receiving apparatus according to the first embodiment of the present invention;

FIG. 9 is a block diagram illustrating a configuration of the data receiving apparatus according to the first embodiment of the present invention;

FIGS. 10A and 10B conceptually illustrate the details of the MV_FINALIZE command according to the first embodiment of the present invention;

FIG. 11 is a sequence diagram between the data transmitting apparatus and the data receiving apparatus during MOVE processing according to the first embodiment of the present invention;

FIG. 12 is a flow chart illustrating an operation of the data transmitting apparatus according to the first embodiment of the present invention;

FIG. 13 is a flow chart illustrating an operation of confirmation processing of the data transmitting apparatus according to the first embodiment of the present invention;

FIG. 14 is a flow chart illustrating an operation of the data receiving apparatus according to the first embodiment of the present invention;

FIG. 15 is a flow chart illustrating an operation of the data receiving apparatus according to the first embodiment of the present invention;

FIG. 16 is a block diagram illustrating a configuration of the data transmitting apparatus according to the second embodiment of the present invention;

FIG. 17 is a block diagram illustrating a configuration of the data receiving apparatus according to the second embodiment of the present invention;

FIG. 18 is a sequence diagram between the data transmitting apparatus and the data receiving apparatus during MOVE processing according to the second embodiment of the present invention;

FIGS. 19A and 19B illustrate format examples of a data transmission request and a data transmission response according to the second embodiment of the present invention;

FIG. 20 is a flow chart illustrating an operation of the data transmitting apparatus according to the second embodiment of the present invention;

FIG. 21 is a flow chart illustrating an operation of confirmation processing of the data transmitting apparatus according to the second embodiment of the present invention;

FIG. 22 is a flow chart illustrating an operation of the data receiving apparatus according to the second embodiment of the present invention;

FIG. 23 is a block diagram illustrating a configuration of the data receiving apparatus according to the third embodiment of the present invention;

FIG. 24 conceptually illustrates a time interval (X) of content data according to the third embodiment of the present invention;

FIG. 25 is a communication sequence diagram which illustrates intervals (Y) at which content data is obtained according to the third embodiment of the present invention;

FIGS. 26A and 26B illustrate format examples of a data transmission request and a data transmission response according to the third embodiment of the present invention;

FIG. 27 is a flowchart that illustrates an operation of the data receiving apparatus according to the third embodiment of the present invention;

FIG. 28 is a block diagram illustrating a configuration of the data transmitting apparatus according to the forth embodiment of the present invention; and

FIG. 29 is a flowchart that illustrates an operation of the data transmitting apparatus according to the forth embodiment of the present invention.

### DESCRIPTION OF THE PREFERRED EMBODIMENTS

### First Embodiment

Embodiments according to the present invention will be described below with reference to the drawings.

### First Embodiment

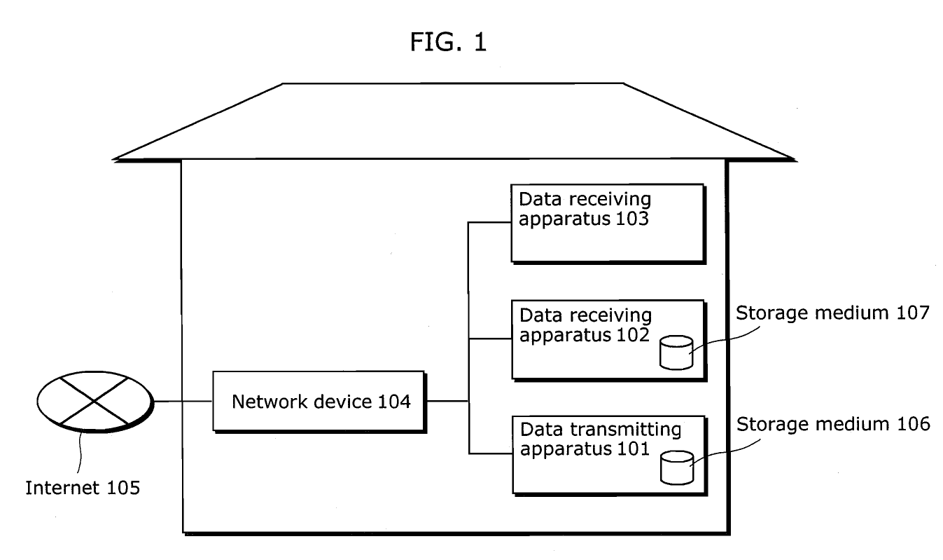

FIG. 1 is a schematic view illustrating a data transmitting and receiving system in a network environment according to the first embodiment of the present invention. In FIG. 1, a data transmitting apparatus 101, a data receiving apparatus 102, and a data receiving apparatus 103 are connected to a network device 104 to configure a home network.

The network device 104 is, for example, a broadband router and connects the data transmitting apparatus 101, the data receiving apparatus 102, and the data receiving apparatus 103 via a network (hereinafter referred to as home network).

Note that the network device 104 may be connected to the Internet 105.

The data transmitting apparatus 101 corresponds to the data transmitting apparatus according to the present invention and transmits content data having use restriction. More specifically, the data transmitting apparatus 101 incorporates a storage medium 106 and is capable of storing content data. Here, the data transmitting apparatus 101 is, for example, a DVD/HDD (Digital Versatile Disc/Hard Disc Drive) hybrid recorder that includes a network connecting terminal.

The data receiving apparatus 102 corresponds to the second data receiving apparatus according to the present invention. More specifically, the data receiving apparatus 102 incorporates a storage medium 107 and is capable of storing content data. Here, the data receiving apparatus 102 is, for example, the DVD/HDD hybrid recorder that includes a network connecting terminal.

The data receiving apparatus 103 corresponds to the first data receiving apparatus according to the present invention. Here, the data receiving apparatus 103 is a terminal used only for a viewing purpose and does not include a storage medium.

Note that the data receiving apparatus 103 may include a storage medium. A file transferring (MOVE) will be described next.

The data transmitting apparatus 101 stores the content data including copy control information of Copy One Generation in the storage medium 106, and the content data stored in the storage medium 106 is subjected to MOVE (transferring) processing to the data receiving apparatus 102 via the home network.

In the DTCP-IP, Encryption Mode Indicator (hereinafter abbreviated as EMI) is defined as copy control information regarding content data. The EMI includes the following four values: (i) Copy Never; that is, a file copying is totally prohibited; (ii) Copy One Generation; that is, a copying is allowed for only a single generation (note that, this information is changed to (iii) Copy No More subsequent to the one generation copying); (iii) Copy No More; and (iv) Copy Free; that is, a copying can be performed freely. In the case of (ii) Copy One Generation, it is not allowed for an apparatus which stores data that has been copied one generation to make a copy of the copied data to be stored in another device. However, transferring the data (MOVE) is allowed. It is defined in the DTCP-IP that a data transmitting apparatus which is a source of transferring should delete or invalidate the data immediately after transferring the data. Here, to delete data means to erase data completely from the storage medium in the data transmitting apparatus. Further, to invalidate data means to render data inaccessible in some way, although the data exists in the storage medium of the source device. Descriptions with regard to a method of deleting data and a method of invalidating data will be omitted, since they are not the focus of the present invention. Further, to transfer data means to delete or invalidate data subsequent to transferring the data, and also includes to delete or invalidate the data after the entire data of content data has been transmitted.

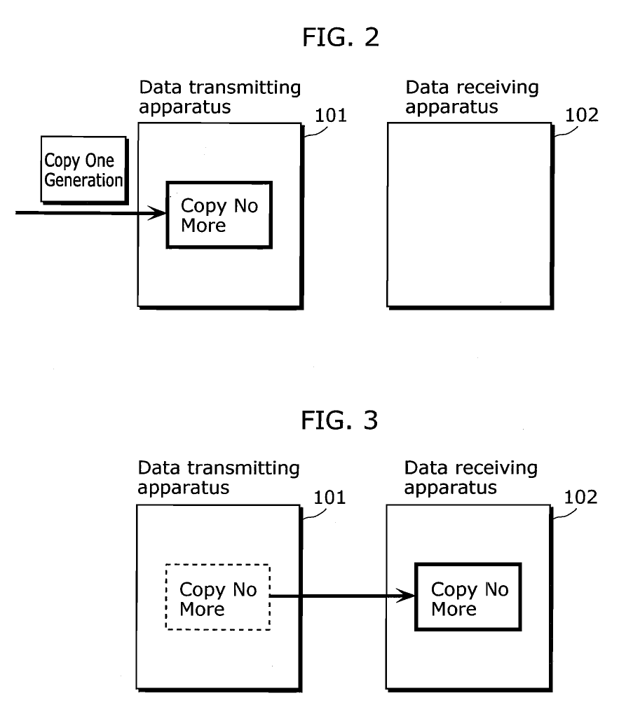

FIG. 2 conceptually illustrates a process of recording, into the data transmitting apparatus 101, content data which can be copied One Generation.

The data transmitting apparatus 101, when receiving content data which can be copied One Generation, changes the EMI of the content data from Copy One Generation to Copy No More that indicates further copying is not allowed and stores the content data in the storage medium 106.

FIG. 3 conceptually illustrates a process of transferring content data of Copy No More recorded in the data transmitting apparatus 101 to the data receiving apparatus 102.

The data transmitting apparatus 101 deletes or invalidates the content data of Copy No More, after the MOVE (transferring) processing of the content data to the data receiving apparatus 102.

Next, a description will be given of MOVE that is under consideration in the DTCP-IP.

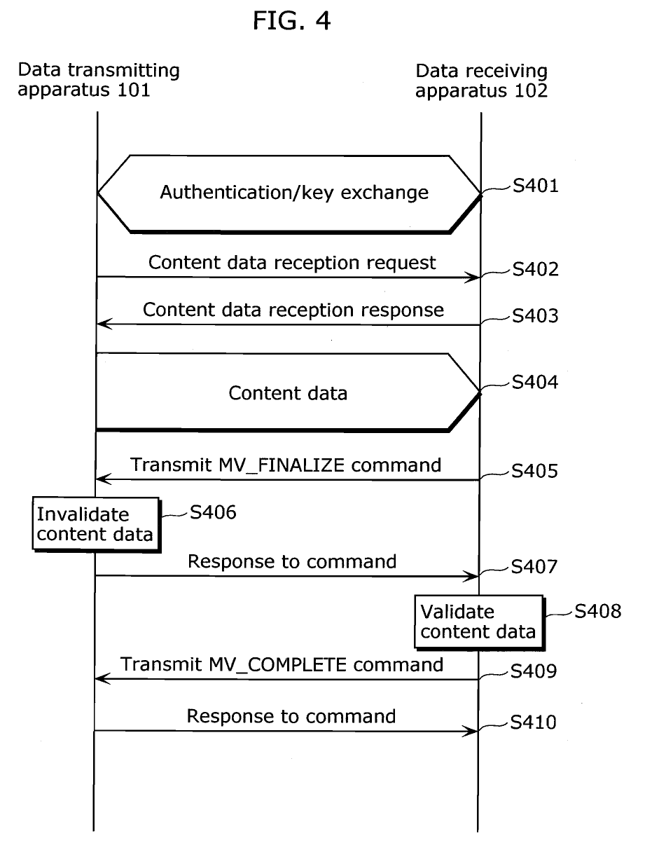

FIG. 4 is a sequence diagram between the data transmitting apparatus and the data receiving apparatus during MOVE processing defined in the DTCP-IP.

First, the data transmitting apparatus 101 and the data receiving apparatus 102 performs authentication defined in the DTCP-IP and key exchange (Authentication and Key Exchange) to share an exchanged key (Kx) to be used for encryption and decryption of content data (S401).

Note that, with regard to the details of the authentication and the key exchange, reference should be made to Non patent reference 1 and Non patent reference 3.

Next, subsequent to the sharing of the key exchange (Kx), the data transmitting apparatus 101 transmits a data reception request, to the data receiving apparatus 102, for determining whether the data receiving apparatus 102 can receive the content data to be transmitted (S402).

The data receiving apparatus 102 transmits to the data transmitting apparatus 101, subsequent to the receipt of the data reception request from the data transmitting apparatus 101, a data reception response that indicates the content data to be transmitted from the data transmitting apparatus 101 can be received (S403).

In the case where the data receiving apparatus 102 cannot receive the content data, the data receiving apparatus 102 transmits an error in place of the data reception response.

Note that, although the data transmitting apparatus 101 transmits the data reception request here, it may also be possible for the data receiving apparatus 102 to transmit a data transmission request for determining whether or not the data transmitting apparatus 101 can transmit the content data to be received by the data receiving apparatus 102.

Next, when the data transmitting apparatus 101 receives the data reception response from the data receiving apparatus 102, the data transmitting apparatus 101 transmits an encrypted content data to the data receiving apparatus 102 (S404). The data transmitting apparatus 101 holds the content data stored therein, with the content data being validated in the storage medium 106, during the MOVE (transferring) processing of the content data from the data transmitting apparatus 101 to the data receiving apparatus 102. The data receiving apparatus 102 which is the destination of the content data records the content data received from the data transmitting apparatus 101 into the storage medium 107, with the content data being invalidated.

The data receiving apparatus 102 transmits to the data transmitting apparatus 101, subsequent to the completion of receiving the content data, a MV_FINALIZE command for requesting invalidation of the content data (S405). The data transmitting apparatus 101, when receiving the MV_FINALIZE command from the data receiving apparatus 102, starts invalidation of the content data stored in the storage medium 106 (S406).

Next, the data transmitting apparatus 101, when the invalidation of the content data is completed, transmits to the data receiving apparatus 102 a response to the MV_FINALIZE command for notifying of the completion of invalidation of the content data (S407).

Next, the data receiving apparatus 102, when receiving the response to the MV_FINALIZE command from the data transmitting apparatus 101, validates the received content data stored in the storage medium 107 (S408).

Next, the data receiving apparatus 102, when the validation of the content data stored in the storage medium 107 is completed, transmits to the data transmitting apparatus 101 a MV_COMPLETE command for notifying of the completion of the validation of the content data (S409).

Next, subsequent to the receipt of the MV_COMPLETE command from the data receiving apparatus 102, the data transmitting apparatus 101 transmits a response to the MV_COMPLETE command from the data receiving apparatus 102 and completes the MOVE processing (S410).

Descriptions will here be given of the MV_FINALIZE command and the MV_COMPLETE command.

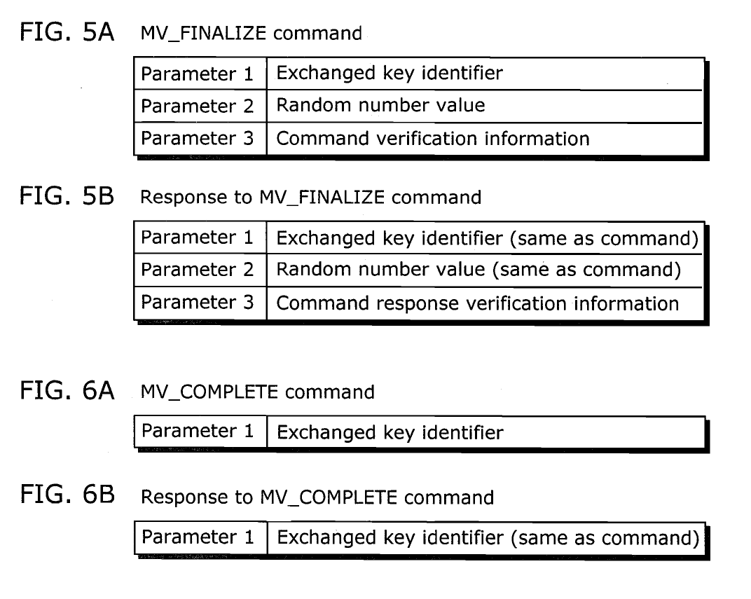

FIG. 5A conceptually illustrates the details of the MV_FINALIZE command of the DTCP-IP. The MV_FINALIZE command includes, as parameters, an exchanged key identifier, a random number value, and command verification information.

The exchanged key identifier is an identifier that is assigned to an exchanged key (Kx). In the authentication and key exchange process (S401), the data receiving apparatus 102 receives a parameter of the exchanged key identifier from the data transmitting apparatus 101.

The random number value is a value that is generated prior to the transmission of the MV_FINALIZE command by the data receiving apparatus 102. The random number value is used for generating the command verification information.

The command verification information is electronic signature information that is generated by using the exchanged key (Kx) and the random number value. The 80 most significant bits of the electronic signature information are set as the command verification information. With the command verification information being added, it is possible to prevent tampering on commands.

FIG. 5B conceptually illustrates the details of the response to the MV_FINALIZE command of the DTCP-IP. The response to the MV_FINALIZE command includes as parameters, similarly to the MV_FINALIZE command, an exchanged key identifier, a random number value, and command verification information.

For the exchanged key identifier and the random number value, the same values of the exchanged key identifier and the random number value set in the MV_FINALIZE command are set, respectively, in the response to the MV_FINALIZE command.

The command verification information is electronic signature information that is generated by using the exchanged key (Kx) and the random number value. The 80 least significant bits of the electronic signature information are set as the command verification information in the response to the MV_FINALIZE command.

FIG. 6A conceptually illustrates the details of the MV_COMPLETE command of the DTCP-IP.

The exchanged key identifier is an identifier that is assigned to the exchanged key (Kx). In the authentication and key exchange process (S401), the data receiving apparatus 102 receives a parameter of the exchanged key identifier from the data transmitting apparatus 101. For the exchanged key identifier, the same value of the exchanged key identifier set in the MV_FINALIZE command is set.

FIG. 6B conceptually illustrates the details of the MV_COMPLETE command of the DTCP-IP.

The response to the MV_COMPLETE command includes the exchanged key identifier as a parameter, similarly to the MV_COMPLETE command.

For the exchanged key identifier, the same value of the exchanged key identifier set in the MV_COMPLETE command is set in the response to the MV_COMPLETE command.

Next, the internal configuration of the data transmitting apparatus 101, the data receiving apparatus 102, and the data receiving apparatus 103 will be described.

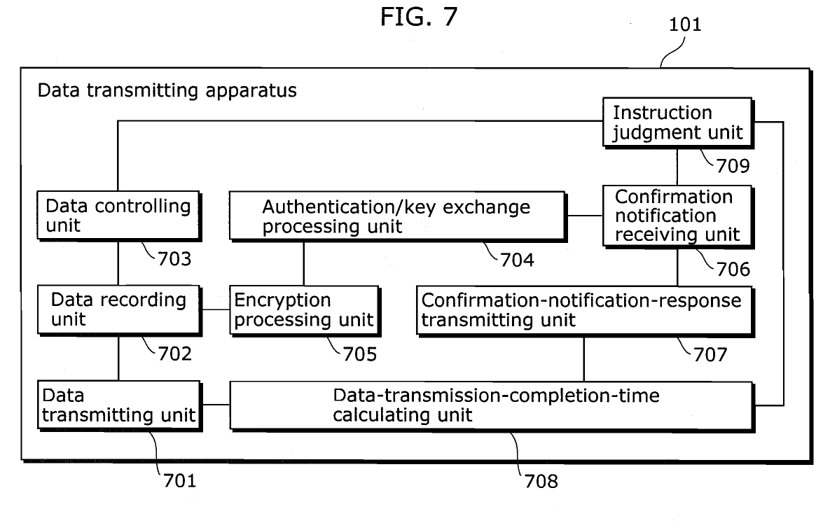

FIG. 7 is a block diagram illustrating a configuration of the data transmitting apparatus 101 according to the first embodiment of the present invention.

The data transmitting apparatus 101 includes: a data transmitting unit 701; a data recording unit 702; a data controlling unit 703; an authentication and key exchange processing unit 704; an encryption processing unit 705; a confirmation notification receiving unit 706; a confirmation-notification-response transmitting unit 707; a data-transmission-completion-time calculating unit 708; and an instruction judgment unit 709.

The data transmitting unit 701 transmits an encrypted content data to the data receiving apparatus 102 or the data receiving apparatus 103.

The data recording unit 702 records the content data. The data recording unit 702 may record the content data into the storage medium 106 connected thereto, or may include the storage medium 106. The data recording unit 702, or the storage medium 106 in the data recording unit 702 is, for example, a Hard Disk Drive (hereinafter abbreviated as HDD), a Flash Disk, a Digital Video Disk (hereinafter abbreviated as DVD), a Secure Digital Memory Card (hereinafter abbreviated as SD memory card), and a Blu-ray Disc (hereinafter abbreviated as BD).

The data controlling unit 703 controls validation and invalidation of the content data that is recorded into the data recording unit 702. Note that detailed description regarding the control of validation and invalidation will be omitted, since it is not the focus of the present invention.

The authentication and key exchange processing unit 704 performs the authentication and key exchange, as described in S401, with the data receiving apparatus 102 or the data receiving apparatus 103.

The encryption processing unit 705 encrypts the content data recorded in the data recording unit 702 using an encryption key (Kc) which is generated using exchange key information (Kx) which has been shared with the data receiving apparatus in the key exchange process.

The confirmation notification receiving unit 706 receives the MV_FINALIZE command and the MV_COMPLETE command from the data receiving apparatus 102.

The confirmation-notification-response transmitting unit 707 generates a response to the MV_FINALIZE command and a response to the MV_COMPLETE command from the data receiving apparatus 102, and transmits the responses to the data receiving apparatus 102.

In the case where the data-transmission-completion-time calculating unit 708 performs the calculation of a data-transmission-completion time that is an amount of time required for transmitting the content data to the data receiving apparatus 103, the confirmation-notification-response transmitting unit 707 sets the calculated data-transmission-completion time in the response to the MV_FINALIZE command and transmits the response to the MV_FINALIZE command to the data receiving apparatus 102. How to set the data-transmission-completion time will be described later.

The data-transmission-completion-time calculating unit 708 calculates a data-transmission-completion time for completing a transmission of content data to be transmitted or being transmitted from the data transmitting apparatus 101 to the data receiving apparatus 103. The data-transmission-completion time is calculated using a transmission rate and a size of the content data that is being transmitted. How to calculate the data-transmission-completion time is presented below.

data-transmission-completion time (second)=content data size (MByte)÷average transmission rate of content data (Mbps)

For example, when the size (amount) of content data is 2 GBytes (2000 MBytes) and the average transmission rate of content data is 16 Mbps, the data-transmission-completion time required from the start to the end of transmitting the data is, obtained by 2000÷16÷8, approximately 1000 seconds.

The instruction judgment unit 709 instructs invalidation of content data stored in the data transmitting apparatus 101 or calculation of the data-transmission-completion time. The instruction judgment unit 709, when receiving the MV_FINALIZE command, instructs the data controlling unit 703 to perform invalidation of the content data stored in the data transmitting apparatus 101, in the case where the content data stored in the data transmitting apparatus 101 has not been transmitted, during a MOVE processing of the content data, to the data receiving apparatus 103 which is an apparatus different from the data receiving apparatus 102 that is the destination of the MOVE.

Further, the instruction judgment unit 709, when receiving the MV_FINALIZE command, does not instruct the data controlling unit 703 to perform invalidation of the content data stored in the data transmitting apparatus 101, in the case where the content data stored in the data transmitting apparatus 101 has been transmitted, during the MOVE processing of the content data, to the data receiving apparatus 103 which is the apparatus different from the data receiving apparatus 102 that is the destination of the MOVE. The instruction judgment unit 709 instructs the data-transmission-completion-time calculating unit 708 to calculate the data-transmission-completion time. Here, the case where the content data stored in the data transmitting apparatus 101 has been transmitted, during the MOVE processing of the content data, to the data receiving apparatus 103 which is the apparatus different from the data receiving apparatus 102 that is the destination of the MOVE, corresponds to the case, for example, where the data transmitting apparatus 101 performs a MOVE processing for the data receiving apparatus 102 while a user is viewing the content data stored in the data transmitting apparatus 101 using the data receiving apparatus 103.

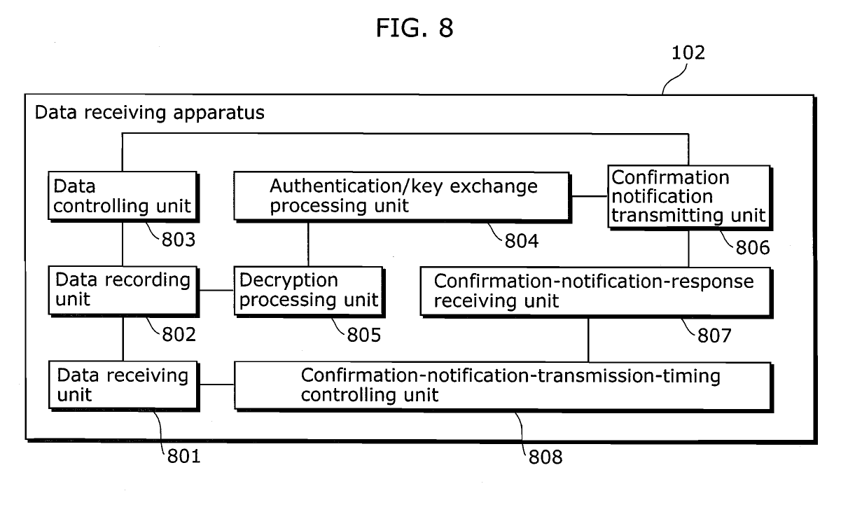

FIG. 8 is a block diagram illustrating a configuration of the data receiving apparatus 102 according to the first embodiment of the present invention.

The data receiving apparatus 102 includes: a data receiving unit 801; a data recording unit 802; a data controlling unit 803; an authentication/key exchange processing unit 804; a decryption processing unit 805; a confirmation notification transmitting unit 806; a confirmation-notification-response receiving unit 807; a confirmation-notification-transmission-timing controlling unit 808.

Descriptions concerning the data recording unit 802, the data controlling unit 803, and the authentication and key exchange processing unit 804 are omitted since they are similar to the data recording unit 702, the data controlling unit 703, and the authentication and key exchange processing unit 704, respectively.

The data receiving unit 801 receives an encrypted content data from the data transmitting apparatus 101.

The decryption processing unit 805 decrypts the content data recorded in the data recording unit 702 using an encryption key (Kc) which is generated using exchange key information (Kx) which has been shared with the data transmitting apparatus 101 in the key exchange process.

The confirmation notification transmitting unit 806 transmits a MV_FINALIZE command and a MV_COMPLETE command to the data transmitting apparatus 101.

The confirmation-notification-response receiving unit 807 receives a response to the MV_FINALIZE command and a response to the MV_COMPLETE command from the data transmitting apparatus 101. In the case where the received response to the MV_FINALIZE command includes the data-transmission-completion time, the confirmation-notification-response receiving unit 807 sets the value of the data-transmission-completion time included in the received response to the MV_FINALIZE command in the confirmation-notification-transmission-timing controlling unit 808.

The confirmation-notification-transmission-timing controlling unit 808 instructs, after the data-transmission-completion time has passed, the confirmation notification transmitting unit 806 to retransmit the MV_FINALIZE command to the data transmitting apparatus 101, in the case where the data-transmission-completion time is set by the confirmation-notification-response receiving unit 807.

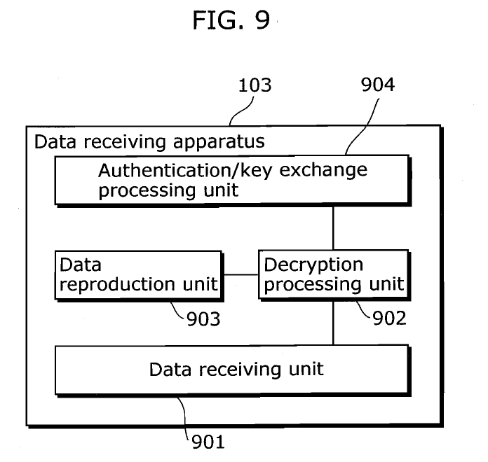

FIG. 9 is a block diagram illustrating a configuration of the data receiving apparatus 103 according to the first embodiment of the present invention. The data receiving apparatus 103 includes: a data receiving unit 901; a decryption processing unit 902; a data reproduction unit 903; and an authentication and key exchange processing unit 904.

Descriptions concerning the data receiving apparatus 901, the decryption processing unit 902, and the authentication and key exchange processing unit 904 are omitted since they are similar to the data receiving unit 801, the decryption processing unit 805, and the authentication and key exchange processing unit 804, respectively.

The data reproduction unit 903 reproduces content data decrypted by the decryption processing unit 902.

How to set the data-transmission-completion time will be described next.

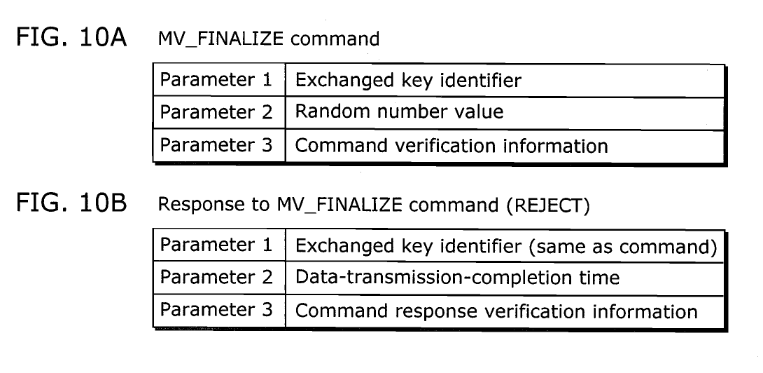

FIGS. 10A and 10B conceptually illustrate the details of the MV_FINALIZE command and the response to the MV_FINALIZE command according to the first embodiment of the present invention.

The same values as described in FIG. 5B are set as the parameters other than the parameter 2 that sets a random number value.

In the case where the data transmitting unit 701 transmits the content data stored in the data transmitting apparatus 101 to the data receiving apparatus 103 which is the apparatus different from the data receiving apparatus 102 for which MOVE processing is carried out, the confirmation-notification-response transmitting unit 707 of the data transmitting apparatus 101, when the MV_FINALIZE command from the data receiving apparatus 102 is received by the confirmation notification receiving unit 706, sets the data-transmission-completion time calculated by the data-transmission-completion-time calculating unit 708 as the parameter for the random number value included in the response to the MV_FINALIZE command. The command verification information is generated by using the exchanged key (Kx) and the random number values set in the MV_FINALIZE command.

The confirmation-notification-response receiving unit 807 of the data receiving apparatus 102 analyzes the MV_FINALIZE command which has been received from the data transmitting apparatus 101. In the case where the random number value included in the response to the MV_FINALIZE command which has been received by the confirmation-notification-response receiving unit 807 is different from the random number value included in the MV_FINALIZE command which has been transmitted from the confirmation notification transmitting unit 806 and the verification of the verification information has succeeded, the confirmation-notification-response receiving unit 807 determines that the data-transmission-completion time has been set in the random number value, and sets the data-transmission-completion time in the confirmation-notification-transmission-timing controlling unit 808.

In the case where the random number value included in the received response to the MV_FINALIZE command is the same as the random number value included in the transmitted MV_FINALIZE command and the verification of the verification information has succeeded, the confirmation-notification-response receiving unit 807 of the data receiving apparatus 102 determines that the data-transmission-completion time has not been set, and instructs the confirmation notification transmitting unit 806 of the data receiving apparatus 102 to transmit the MV_COMPLETE command.

A communication sequence, in which the present invention is applied, will be described next.

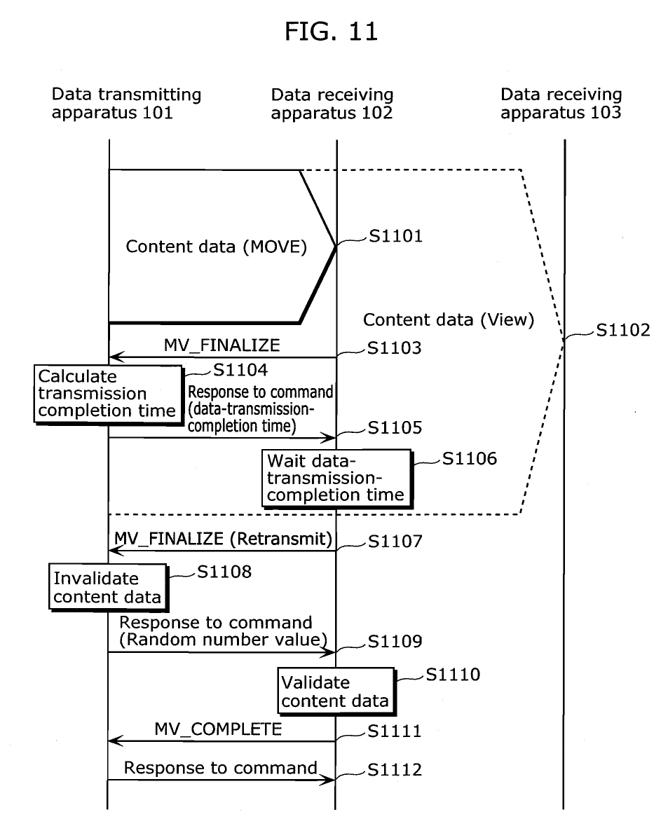

FIG. 11 is a communication sequence diagram between the data transmitting apparatus 101 and the data receiving apparatus 102 in the case where the MOVE processing according to the first embodiment of the present invention is carried out.

Here, FIG. 11 is the communication sequence diagram between the data transmitting apparatus 101 and the data receiving apparatus 102 in the case where, during the MOVE processing of the content data, content data is transmitted to the data receiving apparatus 103 which is an apparatus different from the data receiving apparatus 102 that is the MOVE destination, in other words, in the case where the MOVE processing is carried out by the data transmitting apparatus 101 for the data receiving apparatus 102, while a user is viewing, using the data receiving apparatus 103, the content data stored in the data transmitting apparatus 101.

First, in the case where the transfer of the content data carried out by the data receiving apparatus 102 has been completed (S1101) while the user is viewing the content data using the data receiving apparatus 103 (S1102), the data receiving apparatus 102 transmits the MV_FINALIZE command to the data transmitting apparatus 101 (S1103).

Next, the data transmitting apparatus 101 calculates the data-transmission-completion time which is the time required for completing the data transmission of the content data to be transmitted or being transmitted to the data receiving apparatus 103 from the data transmitting apparatus 101, since the viewing of the content data using the data receiving apparatus 103 by the user is being carrying on (S1104).

Next, the data transmitting apparatus 101 transmits the data-transmission-completion time which has been calculated to the data receiving apparatus 102 by setting the data-transmission-completion time as a parameter of the random number included in the response to the MV_FINALIZE command (S1105).

Next, the data receiving apparatus 102, in the case where the data-transmission-completion time has been set in the received response to the MV_FINALIZE command, waits until the data-transmission-completion time ends (S1106).

Next, the data receiving apparatus 102 retransmits the MV_FINALIZE command to the data transmitting apparatus 101 after the data-transmission-completion time has passed (S1107).

Next, the data transmitting apparatus 101 invalidates the content data stored in the data transmitting apparatus 101, in the case where the viewing of the content data using the data receiving apparatus 103 has been completed when the MV_FINALIZE command is received from the data receiving apparatus 102 (S1108).

Next, the data transmitting apparatus 101 sets a usual random number value in the response to the MV_FINALIZE command and transmits to the data receiving apparatus 102 (S1109). Here, the usual random number value is a random number value that has been generated prior to the transmission of the MV_FINALIZE command by the data receiving apparatus 102.

Next, the data receiving apparatus 102 starts validation of the content data stored in the data receiving apparatus 102, in the case where a random number value which has the value same as the random number value included in the transmitted MV_FINALIZE command has been set in the MV_FINALIZE command which has been received from the data transmitting apparatus 101 (S1110).

Next, the data receiving apparatus 102 transmits the MV_COMPLETE command to the data transmitting apparatus 101 (S1111).

Next, the data transmitting apparatus 101, when receiving the MV_COMPLETE command from the data receiving apparatus 102, transmits the response to the MV_COMPLETE command to the data receiving apparatus 102 (S1112).

Next, detailed operations of the data transmitting apparatus 101, the data receiving apparatus 102, and the data receiving apparatus 103 will be described below.

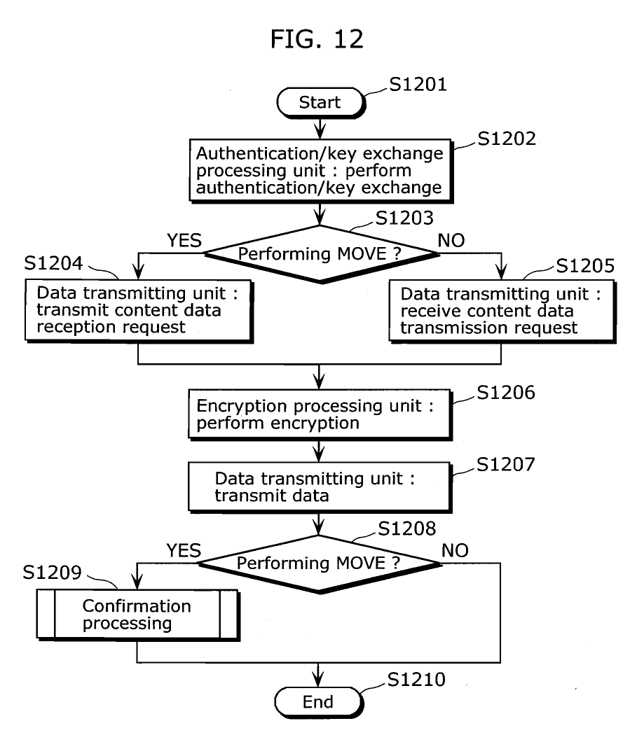

FIG. 12 is a flow chart illustrating an operation of the data transmitting apparatus 101 according to the first embodiment of the present invention.

The authentication and key exchange processing unit 704 of the data transmitting apparatus 101 performs the authentication and key exchange with the data receiving apparatus 102 (S1202).

Next, in the case where the data transmitting apparatus 101 starts to transmit the content data according to the MOVE (YES, in S1203), the data transmitting unit 701 of the data transmitting apparatus 101 transmits, to the data receiving apparatus 102, a data reception request for determining whether or not the data receiving apparatus 102 can receive the content data to be transmitted (S1204).

However, in the case where the data transmitting apparatus 101 starts to transmit the content data not according to the MOVE (No, in S1203), the data transmitting unit 701 of the data transmitting apparatus 101 waits for a data transmission request, from the data receiving apparatus 102, for determining whether or not the data transmitting apparatus 101 can transmits the content data to be received by the data receiving apparatus 102 (S1205).

Next, the encryption processing unit 705 of the data transmitting apparatus 101 starts to encrypt the content data recorded in the data recording unit 702 (S1206).

Next, the data transmitting unit 701 of the data transmitting apparatus 101 transmits, when the encryption of the content data by the encryption processing unit 705 is completed, the encrypted content data recorded in the data recording unit 702 to the data receiving apparatus 102 (S1207).

Next, the data transmitting apparatus 101 determines whether or not the transmission of the encrypted content data recorded in the data recording unit 702 has been completed (S1208). In the case where the data transmitting apparatus 101 has completed transmitting the content data, or in the case where the data transmitting apparatus 101 has completed transmitting the content data not according to the MOVE, the data transmitting apparatus 101 ends the transmission processing (S1210). Here, in the case where the data transmitting apparatus 101 is transmitting the content data by MOVE, the data transmitting apparatus 101 executes a confirmation processing (S1209).

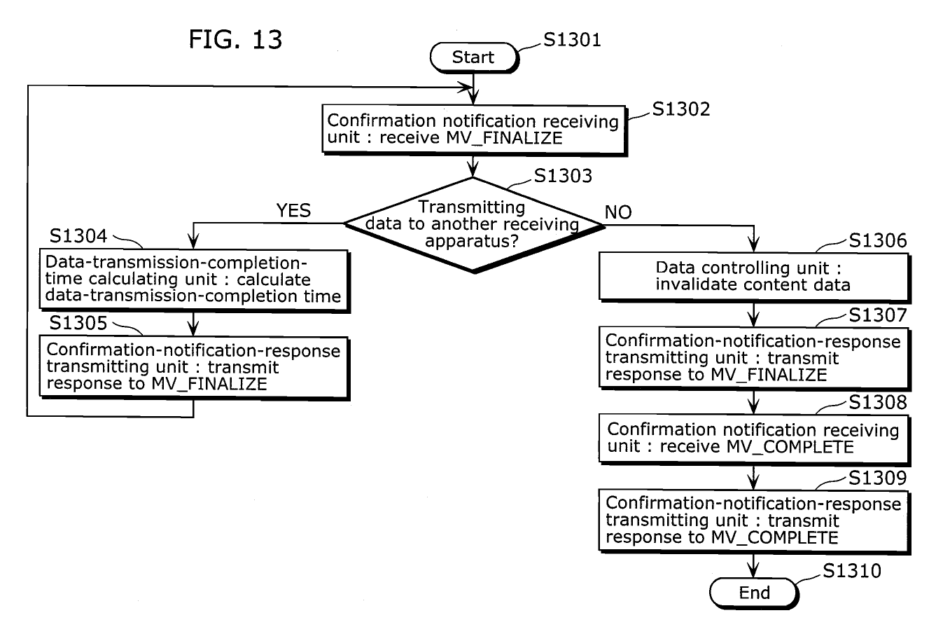

FIG. 13 is a flow chart illustrating an operation of confirmation processing of the data transmitting apparatus 101 according to the first embodiment of the present invention.

First, in the case where the transmission of the content data by the data transmitting apparatus 101 to the data receiving apparatus 102 by MOVE has been completed in S1209, the confirmation notification receiving unit 706 of the data transmitting apparatus 101 receives the MV_FINALIZE command from the data receiving apparatus 102 (S1302).

Next, in the case where the data transmitting apparatus 101 is transmitting the content data, apart from transmitting to the data receiving apparatus 102, to the data receiving apparatus 103 (YES, in S1303), the instruction judgment unit 709 in the data transmitting apparatus 101 instructs the data-transmission-completion-time calculating unit 708 to calculate the data-transmission-completion time that is the time required for transmitting the content data that is being transmitted to the data receiving apparatus 103. The data-transmission-completion-time calculating unit 708 calculates the data-transmission-completion time as instructed by the instruction judgment unit 709 (S1304).

Next, when the data-transmission-completion-time calculating unit 708 completes the calculation of the data-transmission-completion time, the confirmation-notification-response transmitting unit 707 transmits, to the data receiving apparatus 102, the response to the MV_FINALIZE command in which the data-transmission-completion time has been set (S1305). When the confirmation-notification-response transmitting unit 707 transmits the response to the MV_FINALIZE command, the confirmation notification receiving unit 706 waits for the MV_FINALIZE command to be retransmitted from the data receiving apparatus 102.

Note that, in the case where the data transmitting apparatus 101 is not transmitting the content data, apart from transmitting to the data receiving apparatus 102, to the data receiving apparatus 103 (NO, in S1303), the instruction judgment unit 709 in the data transmitting apparatus 101 instructs the data controlling unit 703 to invalidate the content data stored in the data transmitting apparatus 101. The data controlling unit 703 invalidates the content data recorded in the data recording unit 702 in the data transmitting apparatus 101 (S1306).

Next, when the invalidation of the content data stored in the data transmitting apparatus 101 is completed, the confirmation-notification-response transmitting unit 707 in the data transmitting apparatus 101 transmits a response to the MV_FINALIZE command to the data receiving apparatus 102 (S1307).

Next, the confirmation notification receiving unit 706 in the data transmitting apparatus 101 receives the MV_COMPLETE command from the data receiving apparatus 102 (S1308). When the confirmation notification receiving unit 706 in the data transmitting apparatus 101 receives the MV_COMPLETE command, the confirmation-notification-response transmitting unit 707 transmits a response to the MV_COMPLETE command to the data receiving apparatus 102 (S1309).

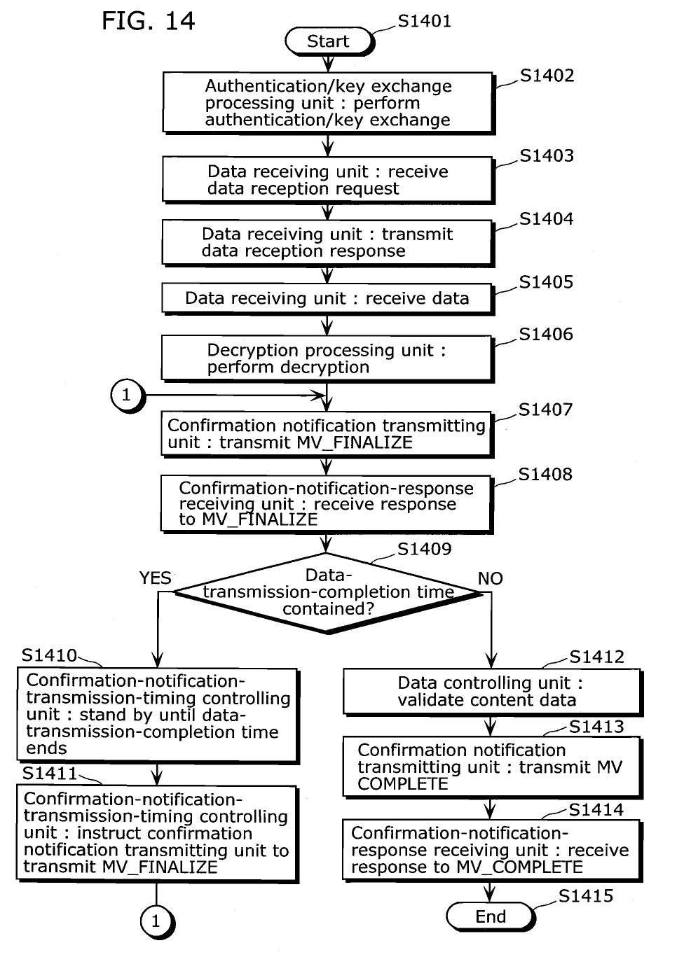

FIG. 14 is a flow chart illustrating an operation of the data receiving apparatus 102 according to the first embodiment.

First, the authentication and key exchange processing unit 804 of the data receiving apparatus 102 performs the authentication and key exchange with the data transmitting apparatus 101 (S1402).

Next, the data receiving unit 801 of the data receiving apparatus 102 receives a data reception request for determining whether the data receiving apparatus 102 can receive the content data (S1403).

Next, the data receiving unit 801 of the data receiving apparatus 102, after receiving the data reception request from the data transmitting apparatus 101, transmits a data reception response that indicates that the content data to be transmitted from the data transmitting apparatus 101 can be received (S1404).

Next, the data receiving unit 801 of the data receiving apparatus 102 receives the encrypted content data from the data transmitting apparatus 101 (S1405), and stores the encrypted content data in the data recording unit 802 of the data receiving apparatus 102.

Next, the decryption processing unit 805 of the data receiving apparatus 102 decrypts the encrypted content data which has been received (S1406). Here, the decryption processing unit 805 of the data receiving apparatus 102 receives the encrypted content data from the data transmitting apparatus 101, and stores the content data while decrypting the encrypted content data.

Next, when receiving the encrypted content data from the data transmitting apparatus 101 is completed, the confirmation notification transmitting unit 806 of the data receiving apparatus 102 transmits the MV_FINALIZE command to the data transmitting apparatus 101 (S1407).

Next, after the MV_FINALIZE command has been transmitted to the data transmitting apparatus 101, the confirmation-notification-response receiving unit 807 of the data receiving apparatus 102 receives, from the data transmitting apparatus 101, a response to the MV_FINALIZE command which is the response command for the MV_FINALIZE command (S1408).

Next, in the case where the response to the MV_FINALIZE command that has been received by the confirmation-notification-response receiving unit 807 of the data receiving apparatus 102 contains the data-transmission-completion time (S1409), the confirmation-notification-transmission-timing controlling unit 808 of the data receiving apparatus 102 stands by until the data-transmission-completion time ends (S1410).

Next, the confirmation-notification-transmission-timing controlling unit 808 of the data receiving apparatus 102, after the data-transmission-completion time has passed, instructs the confirmation notification transmitting unit 806 to retransmit the MV_FINALIZE command to the data transmitting apparatus 101 (S1411).

Note that, in the case where the response to the MV_FINALIZE command that has been received by the confirmation-notification-response receiving unit 807 of the data receiving apparatus 102 does not contain the data-transmission-completion time (No, in S1409), the data controlling unit 803 of the data receiving apparatus 102 validates the content data recorded in the data recording unit 802 of the data receiving apparatus 102 (S1412).

Next, when the validation of the content data performed by the data controlling unit 803 of the data receiving apparatus 102 is completed, the confirmation notification transmitting unit 806 of the data receiving apparatus 102 transmits the MV_COMPLETE command to the data transmitting apparatus 101 (S1413).

Next, after the MV_COMPLETE command has been transmitted to the data transmitting apparatus 101, the confirmation-notification-response receiving unit 807 of the data receiving apparatus 102 receives a response to the MV_COMPLETE command which is the response command for the MV_COMPLETE command from the data transmitting apparatus 101 (S1414).

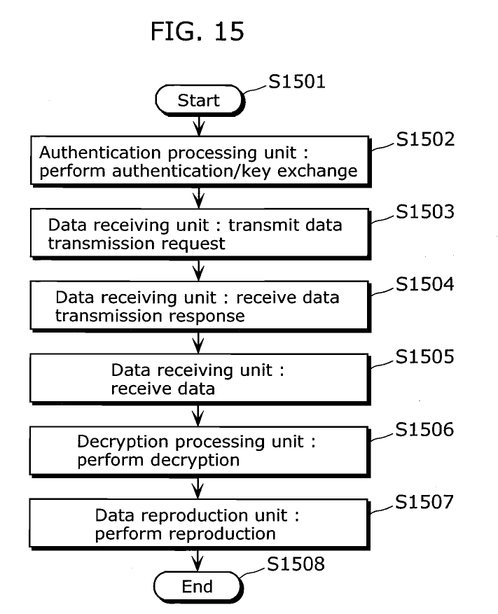

FIG. 15 is a flow chart illustrating an operation of the data receiving apparatus 103 according to the first embodiment.

First, the authentication and key exchange processing unit 904 of the data receiving apparatus 103 performs the authentication and key exchange with the data transmitting apparatus 101 (S1502).

Next, the data receiving unit 901 of the data receiving apparatus 103 transmits, to the data transmitting apparatus 101, a data transmission request for determining whether or not the data transmitting apparatus 101 can transmit the content data to be received by the data receiving apparatus 103 (S1503).

Next, the data receiving unit 901 of the data receiving apparatus 103, after transmitting the data transmission request to the data transmitting apparatus 101, receives a data transmission response indicating that the data transmitting apparatus 101 can transmit the content data to be received by the data receiving apparatus 103 (S1504).

Next, the data receiving unit 901 of the data receiving apparatus 103 receives the encrypted content data from the data transmitting apparatus 101 (S1505).

Next, the decryption processing unit 902 of the data receiving apparatus 103 decrypts the encrypted content data which has been received from the data transmitting apparatus 101 (S1506). Next, the data reproduction unit 903 of the data receiving apparatus 103 reproduces the content data which has been decrypted by the decryption processing unit 902 of the data receiving apparatus 103 (S1507).

According to the first embodiment of the present invention as has been described above, it is possible to prevent an abrupt halt on viewing of content data which the data receiving apparatus 103 is reproducing for viewing, in the case where the data receiving apparatus 102 has started the MOVE processing of the content data stored in the data transmitting apparatus 101, which is being reproduced for viewing by the data receiving apparatus 103, by delaying the notification of MOVE completion to be transmitted from the data receiving apparatus 102 to the data transmitting apparatus 101. Further, it is possible to prevent convergence of a network by calculating the data-transmission-completion time and controlling an interval of retransmitting the confirmation notification transmitted from the data receiving apparatus 102 to the data transmitting apparatus 101.

Note that the data transmitting apparatus 101 may include or may be connected to a reproduction display device for viewing. The data transmitting apparatus 101 may reproduce content data using the reproduction display device of the data transmitting apparatus 101 as well as transmitting the content data to the data receiving apparatus 103. In this case, the data-transmission-completion-time calculating unit 708 of the data transmitting apparatus 101 may notify the data receiving apparatus 102 of the larger value between a reproduction completion time of the reproduction display device for viewing and the aforementioned data-transmission-completion time, as the data-transmission-completion time.

With the data transmitting apparatus 101, the data receiving apparatus 102, the data receiving apparatus 103 and the data transmitting and receiving system according to the present embodiment as has been described above, it is possible for the data receiving apparatus 103 to continue reproducing, without a halt, of content data stored in the data transmitting apparatus 101 for viewing, even in the case where the content data is transmitted (MOVE) to the data receiving apparatus 102 while the data receiving apparatus 103 is reproducing the content data for viewing via a network. Accordingly, it is possible to implement the data transmitting apparatus, the data receiving apparatus, and the data transmitting and receiving system which can prevent an abrupt halt on viewing of content data stored in the data transmitting apparatus 101 while the data receiving apparatus 103 is reproducing the content data.

### Second Embodiment

In the first embodiment, descriptions have been made of the data transmitting apparatus, the data receiving apparatus, and the data transmitting and receiving system which can prioritize viewing and delay the completion of MOVE processing in order to prevent an abrupt halt on viewing of content data stored in the data transmitting apparatus 101 while the data receiving apparatus 103 is reproducing the content data for viewing. In the second embodiment, descriptions will be made of the data transmitting apparatus, the data receiving apparatus, and the data transmitting and receiving system which, when content data which is being subjected to MOVE (transferring) processing from the data transmitting apparatus 201 to the data receiving apparatus 102 is viewed while the data receiving apparatus 203 is reproducing the content data for viewing, can prevent an abrupt halt on the viewing, by notifying that the viewing will be stopped after the MOVE (transferring) processing is completed.

First, descriptions will be made of internal configurations of the data transmitting apparatus 201, the data receiving apparatus 102, and the data receiving apparatus 203.

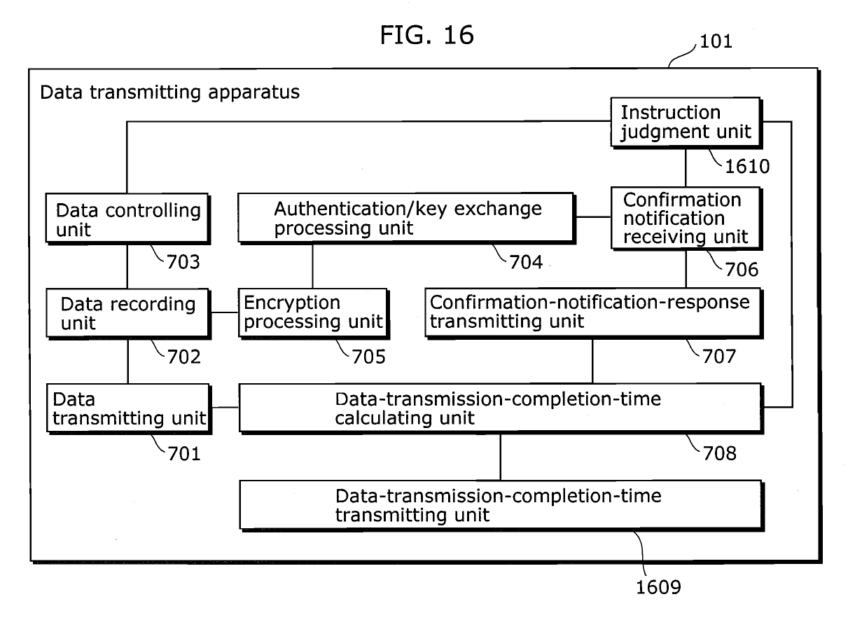

FIG. 16 is a block diagram illustrating a configuration of the data transmitting apparatus 201 according to the second embodiment of the present invention.

The data transmitting apparatus 201 includes: a data transmitting unit 701; a data recording unit 702; a data controlling unit 703; an authentication/key exchange processing unit 704; an encryption processing unit 705; a confirmation notification receiving unit 706; a confirmation-notification-response transmitting unit 707; a data-transmission-completion-time calculating unit 708; a data-transmission-completion-time transmitting unit 1609 and an instruction judgment unit 1610. Differences from the data transmitting apparatus 101 of the first embodiment as illustrated in FIG. 7 are that the data transmitting apparatus 201 includes the data-transmission-completion-time transmitting unit 1609 and the instruction judgment unit 1610 in place of the instruction judgment unit 709.

The data-transmission-completion-time transmitting unit 1609 notifies the data receiving apparatus 203, which has requested transmission of content data stored in the data transmitting apparatus 201 and being subjected to MOVE (transferring) processing from the data transmitting apparatus 201 to the data receiving apparatus 102, of a halt on transmitting the content data to the data receiving apparatus 203, after the data-transmission-completion time from the data transmitting apparatus 201 to the data receiving apparatus 102 ends. In the second embodiment, the data-transmission-completion time is set in a response to a content-data-transmission request from the data receiving apparatus 203, the content data being stored in the data transmitting apparatus 201. The data-transmission-completion time is the time required for completing the MOVE processing for the data receiving apparatus 102. The data transmitting apparatus 201 can notify the data receiving apparatus 203 of a halt on viewing after the data-transmission-completion time ends, by including the data-transmission-completion time in the response to the content-data-transmission request.

Note that, how to notify the data receiving apparatus 203 of the data-transmission-completion time by the data transmitting apparatus 201 will be describe later.

The instruction judgment unit 1610 instructs invalidation of content data stored in the data transmitting apparatus 201 or calculation of the data-transmission-completion time. The instruction judgment unit 1610 instructs the data-transmission-completion-time calculating unit 708 to calculate the data-transmission-completion time in the case where the content data stored in the data transmitting apparatus 201 is being subjected to MOVE (transferring) processing to the data receiving apparatus 102 that is the different apparatus from the data receiving apparatus 203 when the content-data-transmission request from the data receiving apparatus 203 is received.

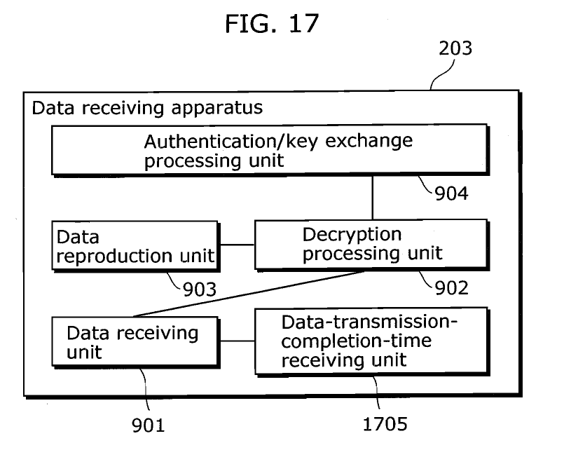

FIG. 17 is a block diagram illustrating a configuration of the data transmitting apparatus 203 according to the second embodiment.

The data receiving apparatus 203 includes: a data receiving unit 901; a decryption processing unit 902; a data reproduction unit 903; an authentication and key exchange processing unit 904; and a data-transmission-completion-time receiving unit 1705. Differences from the data receiving apparatus 103 of the first embodiment as illustrated in FIG. 9 are that the data-transmission-completion-time receiving unit 1705 is included.

The data-transmission-completion-time receiving unit 1705 obtains the data-transmission-completion time from the response to the content-data-transmission request which has been received from the data transmitting apparatus 201. How to use the received data-transmission-completion time includes to alert a user by displaying information which says, for example, “viewing will be stopped in XX seconds” on the screen. Note that the received data-transmission-completion time may be used to be reconnected to a destination of the above-described content data that is being viewed, after the data-transmission-completion time ends in order to view the rest of the content data.

Next, descriptions will be made of a communication sequence between the data transmitting apparatus 201, the data receiving apparatus 102, and the data receiving apparatus 203 during the MOVE processing.

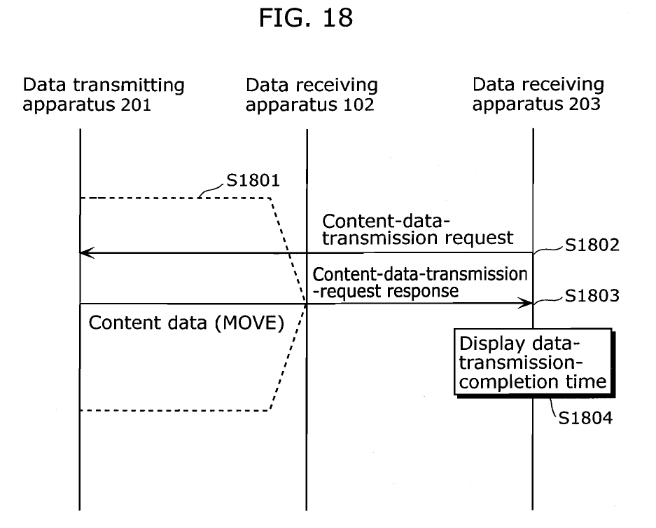

FIG. 18 is a sequence diagram between the data transmitting apparatus and the data receiving apparatus during the MOVE processing according to the second embodiment.

First, the data transmitting apparatus 201 performs MOVE (transferring) processing of content data stored in the data transmitting apparatus 201 to the data receiving apparatus 102 (S1801).

Next, the data receiving apparatus 203 transmits the content-data-transmission request to the data transmitting apparatus 201 (S1802).

Next, the data transmitting apparatus 201, since the content data stored in the data transmitting apparatus 201 is being subjected to the MOVE (transferring) processing, calculates the data-transmission-completion time (MOVE completion time) for the data receiving apparatus 102 and sets the calculated data-transmission-completion time in a response to the request from the data receiving apparatus 203 for transmitting the content data (hereinafter referred to as content-data-transmission-request response) (S1803).

Next, the data receiving apparatus 203, in the case where the data-transmission-completion time has been set in the content-data-transmission-request response received from the data transmitting apparatus 201, displays an information time regarding the received data-transmission-completion time on the screen (S1804).

Next, examples for a format of the content-data-transmission request and the content-data-transmission-request response will be presented. Here, the examples use the HTTP (Hyper Text Transfer Protocol Non patent reference 4).

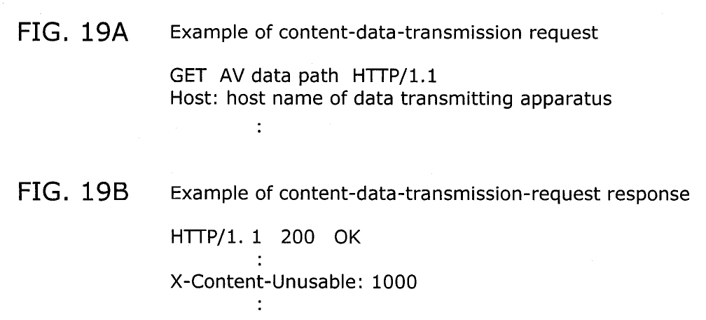

FIG. 19A is an example of a content-data-transmission request, which uses the HTTP.

A Universal Resource Identifier (hereinafter abbreviated as URI) of content data, which the data receiving apparatus 203 has obtained from the data transmitting apparatus 201 in advance, is assigned to a path for the content data.

Further, a name of Domain Name System (hereinafter abbreviated as DNS) of the data transmitting apparatus 201 is set as a host name of the data transmitting apparatus 201.

FIG. 19B is an example of a content-data-transmission-request response which uses the HTTP. X-Content-Unusable is a header field in which the time when the invalidation of content data stars, after MOVE (transferring) processing of the content data has been completed, is set. FIG. 19B indicates that the invalidation of content data stars in 1000 seconds.

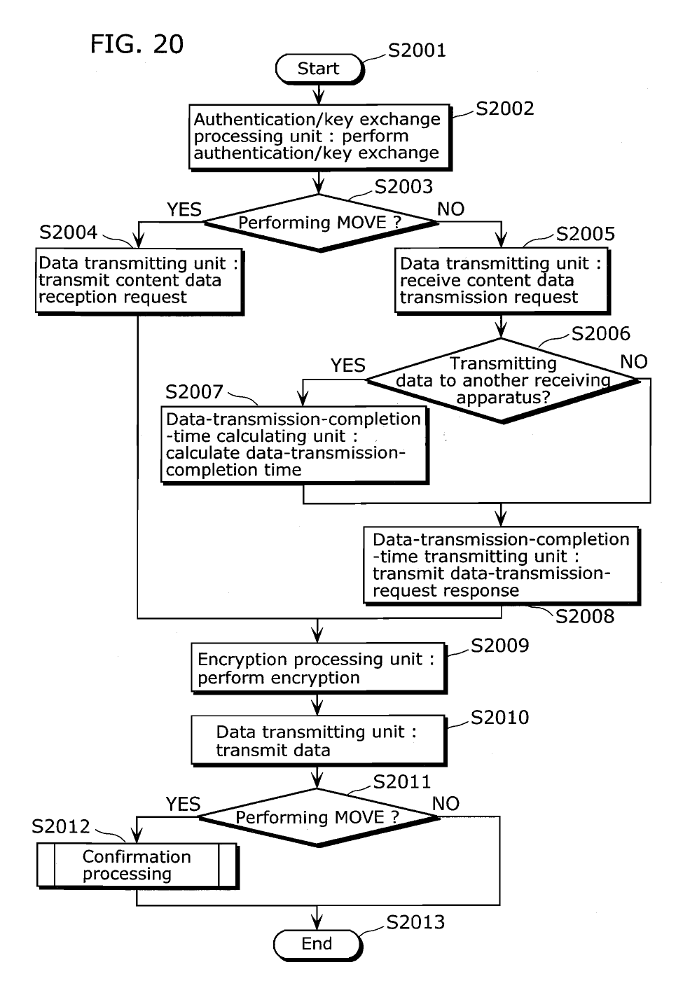

Next, descriptions will be made of operations of the data transmitting apparatus 201 and the data receiving apparatus 203. FIG. 20 is a flowchart that illustrates an operation of the data transmitting apparatus 201 according to the second embodiment. Descriptions of S2001 to S2005 will be omitted since they are similar to the descriptions of S1201 to S1205 of FIG. 12.

In S2005, the data transmitting apparatus 201 receives, from the data receiving apparatus 203, a transmission request which indicates that content data stored in the data transmitting apparatus 201 can be transmitted to the data receiving apparatus 203. In the case where the content data is being subjected to MOVE (transferring) processing for the data receiving apparatus 102 that is the apparatus different from the data receiving apparatus 203 (Yes, in S2006), the instruction judgment unit 1610 of the data transmitting apparatus 201 instructs the data-transmission-completion-time calculating unit 708 to calculate the data-transmission-completion time. The data-transmission-completion-time calculating unit 708 calculates the time when the MOVE (transferring) processing of the content data for the data receiving apparatus 102 is completed (data-transmission-completion time) (S2007).

Next, when the data-transmission-completion-time calculating unit 708 of the data transmitting apparatus 201 completes the calculation of the data-transmission-completion time, the data-transmission-completion-time transmitting unit 1609 of the data transmitting apparatus 201 transmits, to the data receiving apparatus 203, a content-data-transmission-request response in which the data-transmission-completion time calculated by the data-transmission-completion-time calculating unit 708 has been set (S2008).

Note that, Descriptions of S2009 to S2011 will be omitted since they are similar to the descriptions of S1206 to S1208 of FIG. 12.

Further, in the case where the data transmitting apparatus 201 is performing transmission of the content data using the MOVE to the data receiving apparatus 102 in S2011, the data transmitting apparatus 201 performs confirmation processing (S2012). Descriptions of the confirmation processing will be given later.

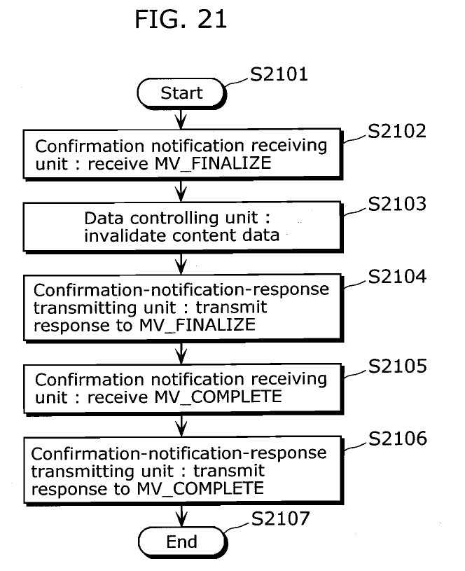

FIG. 21 is a flowchart that illustrates an operation of the data transmitting apparatus 201 in the confirmation processing according to the second embodiment.

Here, descriptions of S2102 will be omitted since they are similar to the descriptions of S1302 of FIG. 13. Further, descriptions of S2103 to S2106 will be omitted since they are similar to the descriptions of S1306 to S1309 of FIG. 13.

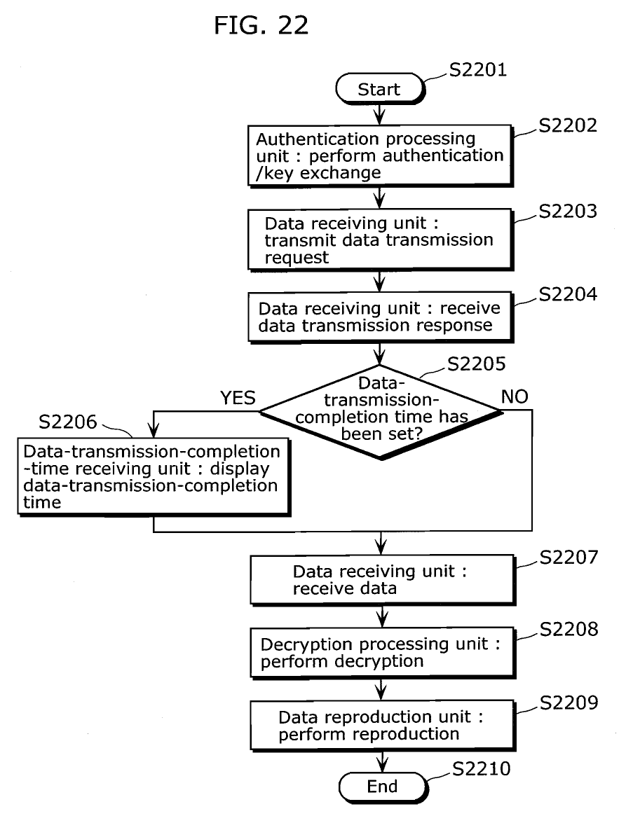

FIG. 22 is a flowchart that illustrates an operation of the data receiving apparatus 203 according to the second embodiment.

Here, descriptions of S2202 to S2204 will be omitted since they are similar to the descriptions of S1502 to S1504 of FIG. 15.

In the case where the data-transmission-completion time has been set in the content-data-transmission-request response received by the data-transmission-completion-time receiving unit 1705 of the data receiving apparatus 203 from the data transmitting apparatus 201 (Yes, in S2205), the data receiving apparatus 203 displays an information time regarding the received data-transmission-completion time on the screen (S2206).

Note that, descriptions of S2207 to S2209 will be omitted since they are similar to the descriptions of S1505 to S1507 of FIG. 15.

With the data transmitting and receiving system including the data transmitting apparatus 201, the data receiving apparatus 102, and the data receiving apparatus 203 according to the second embodiment as has been described above, it is possible to notify in advance that viewing of content data stored in the data transmitting apparatus 201 using the data receiving apparatus 203 will be halted during the viewing, even in the case where the data receiving apparatus 203 reproduces the content data while the content data stored in the data transmitting apparatus 201 is subjected to MOVE (transferring) processing for the data receiving apparatus 102 via a network. With this, it is possible to prevent an abrupt halt on the viewing, while the data receiving apparatus 203 is reproducing the content data stored in the data transmitting apparatus 201 for viewing.

### Third Embodiment

In the third embodiment, a reproduction speed and a reproduction method are changed in the method in which MOVE is given priority as has been described in the second embodiment, thereby allowing a data receiving apparatus 303 to reproduce content data for viewing to the end before MOVE processing is completed.

In the third embodiment, descriptions will be made of a method of reproducing content data at fast speed by the data receiving apparatus 303, before the MOVE processing for the data receiving apparatus 102 performed by the data transmitting apparatus 201 is completed.

Note that, in the third embodiment, descriptions which overlap with those in the second embodiment will be omitted.

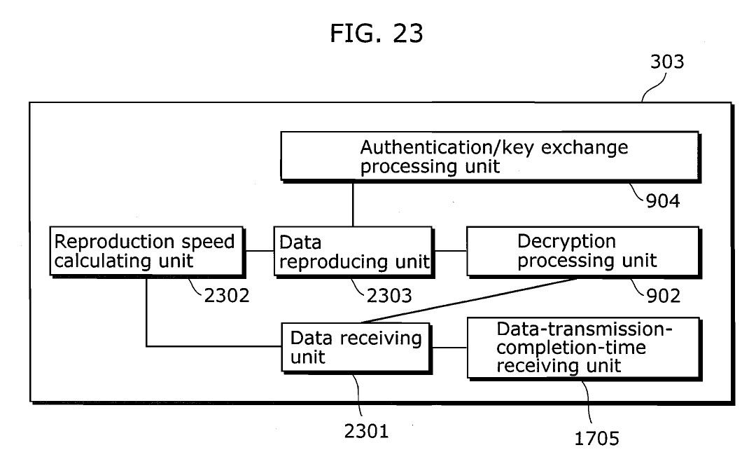

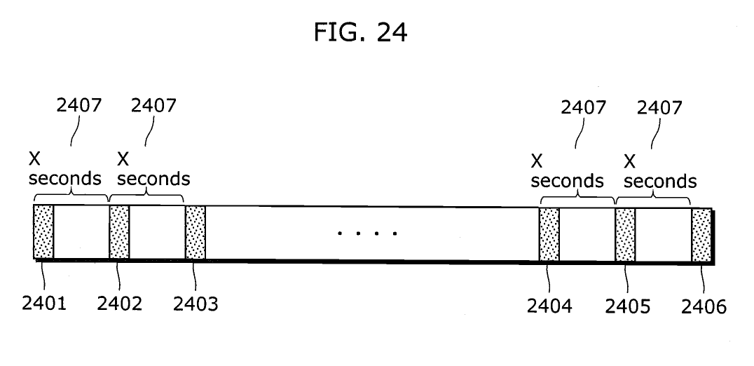

FIG. 23 is a block diagram illustrating a configuration of the data transmitting apparatus 303 according to the third embodiment.

The data receiving apparatus 303 includes: a decryption processing unit 902; an authentication and key exchange processing unit 904; a data-transmission-completion-time receiving unit 1705; a data receiving unit 2301; a reproduction speed calculating unit 2302; and a data reproducing unit 2303. A configuration of the data receiving apparatus 303 of the third embodiment differs from that of the data receiving apparatus 203 of the second embodiment, in that the data receiving apparatus 303 includes the reproduction speed calculating unit 2302 and that the data receiving unit 2301 and the data reproduction unit 2303 are included in the data receiving apparatus 303 in place of the data receiving unit 901 and the data reproduction unit 903 in the data receiving apparatus 203, respectively. Note that the same reference numerals are given to the units similar to the units in FIG. 17 of the second embodiment and detailed descriptions for the similar units will be omitted.

The data receiving unit 2301, as well as the data receiving unit 901 of the second embodiment, receives encrypted content data from the data transmitting apparatus 201.

Further, the data receiving unit 2301 determines a time range of content data to be obtained from the data transmitting apparatus 201, according to a reproduction speed for the content data which has been calculated by the reproduction speed calculating unit 2302.

Here, the data receiving apparatus 303 obtains content data as data groups divided at predetermined time intervals and reproduces the content data. The time range of content data is a range of time of which the data receiving apparatus 303 can reproduce the data group divided at a predetermined time interval as content data.

Note that how to determine the time range of content data to be obtained by the data receiving unit 2301 will be described later.

The reproduction speed calculating unit 2302 calculates a speed of content data according to the data-transmission-completion time which the data-transmission-completion-time receiving unit 1705 has received from the data transmitting apparatus 201.

Here, it is assumed that the data-transmission-completion time received from the data transmitting apparatus 201 is, for example, 360 seconds. It is further assumed that the time of the entire content data is 2 hours (2×60×60=7200 seconds).

In this case, the reproduction speed required for the data receiving apparatus 303 for reproducing the content data is obtained from 7200 (seconds)÷360 (seconds)=20; that is, 20-time reproduction speed.

The data reproduction unit 2303 has a feature of high-speed reproduction, in addition to the features that the data reproduction unit 903 of the second embodiment has. More specifically, the data reproduction unit 2303 reproduces content data which has been decrypted by the decryption processing unit 902. The data reproduction unit 2303 can reproduce the content data decrypted by the decryption processing unit 902 by high-speed reproduction, for example, at 20-time reproduction speed.

The data reproduction unit 2303 performs high-speed reproduction in response to a reproduction-speed instruction for the content data from the reproduction speed calculating unit 2302. Note that detailed descriptions as to the high-speed-reproduction feature will be omitted, since they are not the focus of the present invention.

Next, how the data receiving unit 2301 determines the time range of content data will be described.

An example of implementing high-speed reproduction will be given below.

Here, the data receiving unit 2301 obtains content data with some of data being skipped, or the data reproduction unit 2303 reproduces only I frames of the content data obtained by the data receiving unit 2301, thereby implementing high-speed reproduction.

FIG. 24 conceptually illustrates a time interval (X) of content data according to the third embodiment of the present invention. In FIGS. 24, 2401, 2402, 2403, 2404, 2504, and 2406 denote I frames, and 2407 denotes X-second data in content data.

FIG. 24 illustrates an example of the case in which the data receiving apparatus 303 obtains content data as a group of data 2407 that is a portion of the content data divided at time intervals (X), and reproduces I frames 2401, 2402, 2403, 2404, 2405, and 2406 as content data. Note that, although the data receiving apparatus 303 of the example in the third embodiment obtains content data of the same time as the time interval (X), the content data may be of time different from the time interval (X), and it is sufficient for the amount of the content data to be larger than the amount of I frames 2401, 2402, 2403, 2404, 2405, or 2406.

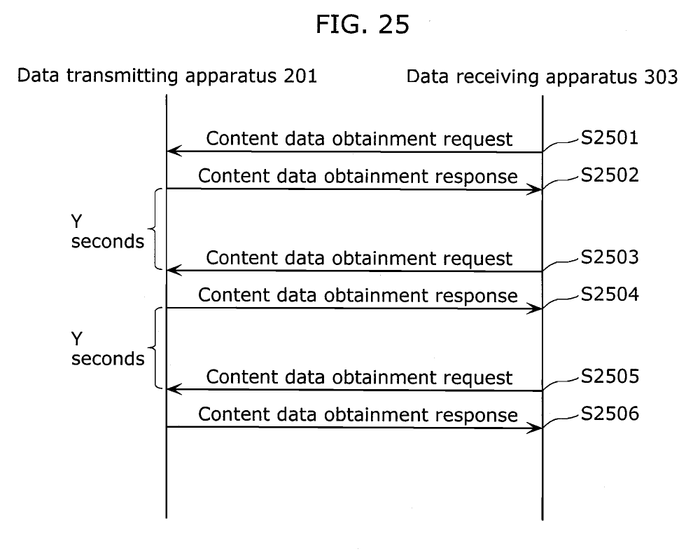

FIG. 25 is a communication sequence diagram which illustrates intervals (Y) at which content data is obtained according to the third embodiment of the present invention.

FIG. 25 illustrates the case in which the data transmitting apparatus 201 transmits a content obtainment response in response to a content obtainment request transmitted from the data receiving apparatus 303, and transmits X-second data 2407 illustrated in FIG. 24 to the data receiving apparatus 303.

In FIG. 25, the data receiving apparatus 303 obtains the X-second data 2407 at intervals of Y seconds. The data receiving apparatus 303 displays the obtained X-second data as content data at intervals of Y seconds.

In the case of high-speed reproduction as described above, the reproduction speed is determined from: the time interval (X) of the content data to be obtained as illustrated in FIG. 24; and the interval (Y) at which the data receiving unit 2301 obtains the content data from the data transmitting apparatus 201 as illustrated in FIG. 25. This is shown by the following expression.

reproduction speed=time interval (X) of content data÷interval (Y) at which the content data is obtained (Expression)

Here, when the time interval (X) of content data is assumed to be 20 seconds and the interval (Y) at which the content data is obtained is assumed to be 1 second, for example, it enables 20-time speed reproduction.

Further, in the case where the 20-time reproduction speed is required for the data receiving apparatus 303 for reproducing the content data, the data receiving unit 2301 sets 20 seconds as the time interval (X) of the content data according to the expression described above, and obtains the content data from the data transmitting apparatus 201 at intervals of 1 second and at 20-second time intervals (X) of the content data.

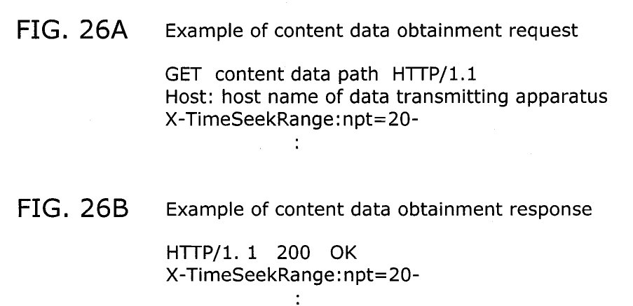

FIGS. 26A and 26B illustrate format examples of a data transmission request and a data transmission response according to the third embodiment of the present invention.

FIG. 26A illustrates an example of a content data obtainment request that is transmitted by the data receiving unit 2301 when obtaining, from the data transmitting apparatus 201, the content data of a 20-second position.

FIG. 26B illustrates an example of a content data obtainment response that is transmitted by the data transmitting apparatus 201 to the data receiving unit 2301.

FIG. 26A illustrates an example case in which the content data of a 20-second position is obtained by using X-TimeSeekRange header.

Here, descriptions will be made using the example illustrated in FIG. 24, for example. The data receiving unit 2301 obtains X-second data 2407 from the data transmitting apparatus 201 and obtains next X-second data 2407. In this case, the data receiving unit 2301 requests a portion of content data, in content data, which starts from the starting-time position of next X-second data 2407 and obtains the portion of content data.

Further, the X-TimeSeekRange header is used when the data receiving apparatus 303 obtains content data from the data transmitting apparatus 201 by designating a position with the starting-time of the content data, and is highly suitable for the present embodiment.

Note that, how to designate a position of content data is not limited to this, but the position of content data may be designated, for example, by an information amount (byte unit).

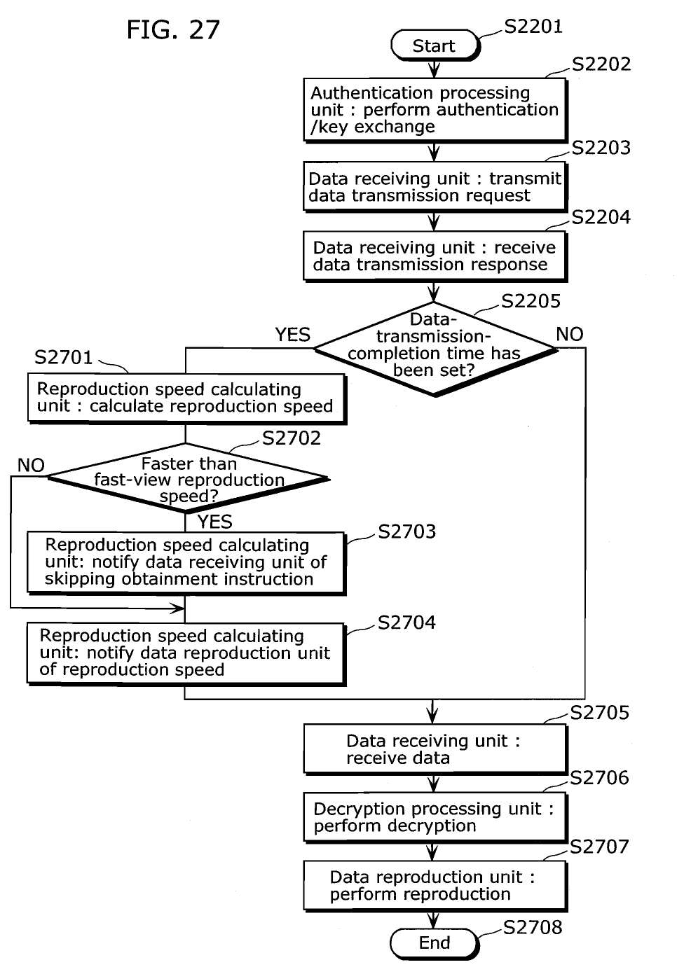

FIG. 27 is a flowchart that illustrates an operation of the data receiving apparatus 303 according to the third embodiment.

Note that descriptions for S2201 to S2205 will be omitted since they are similar to those for S2201 to S2205 in FIG. 22 of the second embodiment.

In S2205, the reproduction speed calculating unit 2302 of the data receiving apparatus 303 determines a reproduction speed for high-speed reproduction according to the data-transmission-completion time included in the content data obtainment response which has been received from the data transmitting apparatus 201 (S2701).

Next, the reproduction speed calculating unit 2302 judges whether or not the reproduction speed for high-speed reproduction which has been determined in S2701 is faster than a fast-view reproduction speed of the data reproducing unit 2303 (S2702).

In the case where, for example, the data reproduction unit 2303 is capable of fast-view reproduction of 1.5-time speed reproduction and the reproduction speed for high-speed reproduction which has been determined in S2701 is slower than the 1.5-time speed, the reproduction speed calculating unit 2302 does not notify the data receiving unit 2301. Accordingly, the data receiving unit 2301 obtains the entire content data and performs the fast-view reproduction by the data reproduction unit 2303.

Here, the fast-view reproduction is a method of high-speed reproduction by which the entire content is obtained and reproduced at high speed with audio, with the content being grasped. In other words, the fast-view reproduction is a method of high-speed reproduction by which the data receiving unit 2301 obtains the entire content data and implements high-speed reproduction without skipping some of the content data.

Next, in the case where the reproduction speed is faster than the 1.5-time speed, a notification of a skipping obtainment instruction is sent to the data receiving unit 2301 so that the content data is obtained by skipping some of the content data (S2703).

Next, the reproduction speed calculating unit 2302 notifies the data reproduction unit 2303 of the reproduction speed (S2704).

Further, the data receiving unit 2301 determines an obtainment time interval of the content data according to the reproduction speed calculated by the reproduction speed calculating unit 2302, and starts to obtain the content data from the data transmitting apparatus 201 (S2705). Here, in the case where the notification of skipping obtainment instruction has been received from the reproduction speed calculating unit 2302, the obtainment time interval of the content data is determined also according to the notification of skipping obtainment instruction.

Next, the decryption processing unit 902 of the data receiving apparatus 303 decrypts the encrypted content data which has been received from the data transmitting apparatus 201 in a similar manner as S2208 of the second embodiment (S2706).

Next, the data reproduction unit 2303, according to the notification of reproduction speed from the reproduction speed calculating unit 2302, reproduces the content data which has been decrypted by the decryption processing unit 902 (S2706).

The content data is reproduced at high speed as has been described above. With this, a user can grasp an overview of the entire content data which is currently viewed, before the content data disappears from the data transmitting apparatus 201 and viewing becomes impossible to continue. This is highly advantageous.

Note that, in the example of the third embodiment, descriptions have been made of the method for viewing a part of content data within the data-transmission-completion time by changing a reproduction speed for the content data. However, the content data may be, for example, reconfigured according to the data-transmission-completion time calculated by the data transmitting apparatus 201 (or 101) and outputted in a digest to the data receiving apparatus 303. With a digest viewing, viewing time can fall within the data-transmission-completion time and a major portion of the content data can be viewed. Accordingly, in the case of sport-relating content data, for example, it is possible to watch a score-getting scene and know a game result, and this is highly advantageous.

### Forth Embodiment

In the forth embodiment, the data transmitting apparatus 101 of the first embodiment and the data transmitting apparatus 201 of the second embodiment can be switched. More specifically, it is possible to switch priorities between MOVE processing for the data receiving apparatus 102 and reproduction for viewing by the data receiving apparatus 103 or 203. In other words, it is possible to select between (i) preventing content data in a data transmitting apparatus 401 from being invalidated or deleted until a data receiving apparatus 403 (the data receiving apparatus 103 or 203) completes reproduction for viewing, and (ii) notifying a user that the data receiving apparatus 403 will stop reproduction for viewing of content data due to completion of MOVE processing for the data receiving apparatus 102.

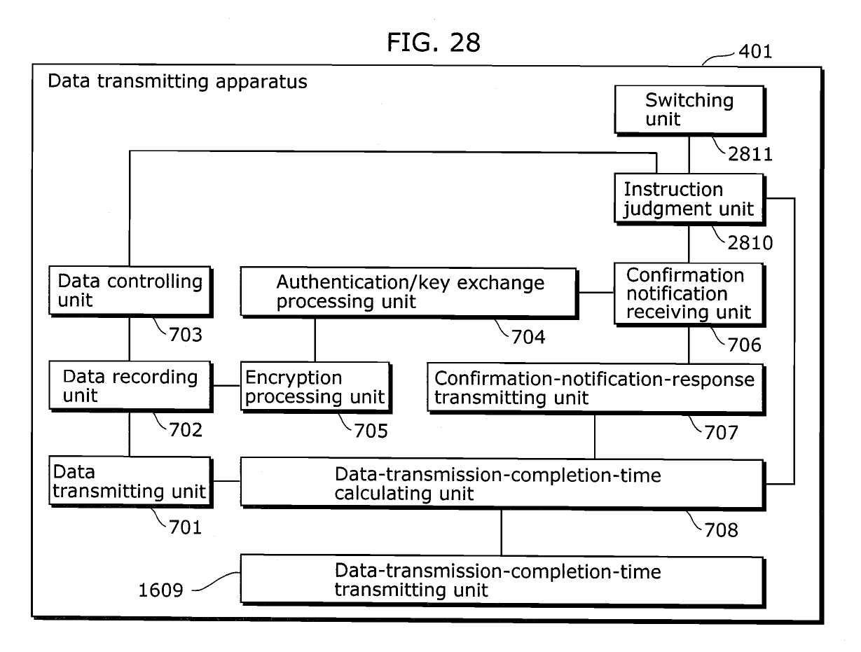

FIG. 28 is a block diagram illustrating a configuration of the data transmitting apparatus 401 according to the forth embodiment.

The data transmitting apparatus 401 includes: a data transmitting unit 701; a data recording unit 702; a data controlling unit 703; an authentication and key exchange processing unit 704; an encryption processing unit 705; a confirmation notification receiving unit 706; a confirmation-notification-response transmitting unit 707; a data-transmission-completion-time calculating unit 708; a data-transmission-completion-time transmitting unit 1609; an instruction judgment unit 2810; and a switching unit 2811.

The data transmitting apparatus 401 of the forth embodiment differs from the data transmitting apparatus 101 of FIG. 7 of the first embodiment and the data transmitting apparatus 201 of FIG. 16 of the second embodiment, in that the data transmitting apparatus 401 includes the switching unit 2811 and the instruction judgment unit 2810 is included in place of the instruction judgment unit 1610. Note that the same reference numerals are given to the units similar to the units in FIG. 7 and FIG. 16 and detailed descriptions for the similar units will be omitted.

The instruction judgment unit 2810 switches functions between the instruction judgment unit 709 of the first embodiment and the instruction judgment unit 1610 of the second embodiment in response to an instruction from the switching unit 2811. More specifically, the instruction judgment unit 2810, when receiving a “transfer completion delaying” instruction from the switching unit 2811, instructs the data controlling unit 703 to invalidate the content data stored in the data transmitting apparatus 401 in the case where the content data stored in the data transmitting apparatus 401 has not been transmitted to the data receiving apparatus 403 at the time of receiving a MV_FINALIZE command from the data receiving apparatus 102.

Further, the instruction judgment unit 2810 does not instruct the data controlling unit 703 to invalidate the content data stored in the data transmitting apparatus 401 in the case where the content data stored in the data transmitting apparatus 401 has been transmitted to the data receiving apparatus 403 at the time of receiving the MV_FINALIZE command from the data receiving apparatus 102. The instruction judgment unit 2810 instructs the data-transmission-completion-time calculating unit 708 to calculate a data-transmission-completion time and set the calculation result into a response to a command which has been transmitted from the confirmation-notification-response transmitting unit 707.

Further, the instruction judgment unit 2810, when receiving an “invalidation notification” instruction from the switching unit 2811, instructs the data-transmission-completion-time calculating unit 708 to calculate a data-transmission-completion time and instructs the data-transmission-completion-time transmitting unit 1609 to set the calculation result, in the case where the content data stored in the data transmitting apparatus 401 has been subjected to MOVE (transfer) processing for the data receiving apparatus 102 at the time of receiving a content-data-transmission request from the data receiving apparatus 403.

The switching unit 2811 instructs the instruction judgment unit 2810 one of the “transfer completion delaying” or the “invalidation notification”. Here, the switching unit 2811 switches between the “transfer completion delaying” and the “invalidation notification” in response to an instruction or a setting by a user.

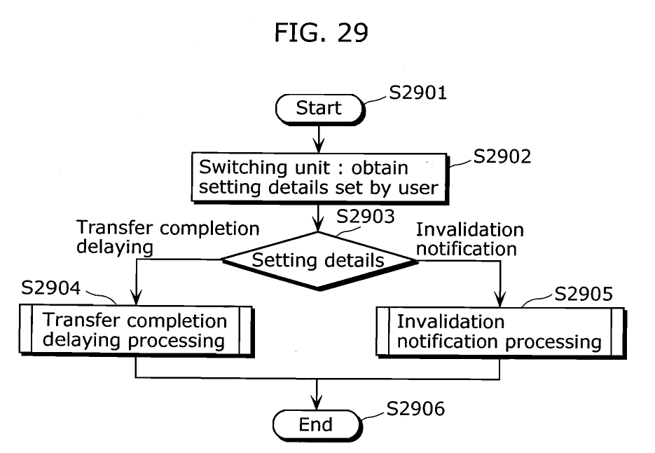

FIG. 29 is a flowchart that illustrates an operation of the data transmitting apparatus 401 according to the forth embodiment.

First, the switching unit 2811 of the data transmitting apparatus 401 obtains setting details which has been set by a user (S2902).

Next, in the case where the “transfer completion delaying” has been set as the setting details by the user (in the case of transfer completion delaying, in S2903), the switching unit 2811 performs the transfer completion delaying processing to prevent the content data in the data transmitting apparatus 401 from being invalidated or deleted until the data receiving apparatus 403 completes reproduction of the content data for viewing (S2904). Here, details of processing in S2904 are the same as those in S1301 to S1310 in FIG. 13 of the first embodiment as described above.

Further, in the case where the “invalidation notification” has been set as the setting details by the user, the switching unit 2811 performs the invalidation notification processing to notify the data receiving apparatus 403 currently reproducing the content data for viewing that viewing of the content data will not be able to continue due to completion of the MOVE processing for the data receiving apparatus 102 performed by the data transmitting apparatus 401 (S2905). Here, detailed descriptions of the processing in S2905 will be omitted, since they are the same as those in S2001 to S2013 in FIG. 20 of the second embodiment as described above.

The data transmitting apparatus 401 of the forth embodiment is capable of switching, as needed, between the transfer completion delaying and the invalidation notification. With this, it is possible to prevent an abrupt halt on viewing of content data stored in the data transmitting apparatus 401 while the data receiving apparatus 403 is reproducing the content data for viewing.

As has been described above, with the data transmitting apparatus, the data receiving apparatus, and the data transmitting and receiving system of the present invention, it is possible to implement the data transmitting apparatus, the data receiving apparatus, and the data transmitting and receiving system which can prevent an abrupt halt on viewing of content data stored in the data transmitting apparatus while the data receiving apparatus is reproducing the content data for viewing.

Although only some exemplary embodiments of the data transmitting apparatus, the data receiving apparatus, and the data transmitting and receiving system of the present invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention can be used for a data transmitting apparatus, a data receiving apparatus, and a data transmitting and receiving system which transmit or transfer, between predetermined devices connected to a network, data that require a copyright protection, and particularly used for a data transmitting apparatus, a data receiving apparatus, and a data transmitting and receiving system which transmit or transfer data that has copy control information of Copy One Generation.

What is claimed is:

1. A data transmitting apparatus which transmits content data having use restriction, said data transmitting apparatus comprising:
a transmitting unit operable: to transmit the content data to a first data receiving apparatus that receives the content data for viewing; and to transmit the content data to a second data receiving apparatus so that the content data is transferred;
a calculation unit operable to calculate a time required for said data transmitting unit to complete transmitting the content data to one of the first data receiving apparatus and the second data receiving apparatus; and
a notification unit operable to notify one of the first data receiving apparatus and the second data receiving apparatus of the time calculated by said calculation unit, the one of the first data receiving apparatus and the second data receiving apparatus being a data receiving apparatus not corresponding to the time.

2. The data transmitting apparatus according to claim 1, further comprising
a control unit operable to change a state of the content data between a usable state and an unusable state,
wherein: said calculation unit is operable to calculate the time required for completing the transmission of the content data to the first data receiving apparatus;
said notification unit is operable: to notify the second data receiving apparatus of the time; and to cause the second data receiving apparatus to transmit, to said data transmitting apparatus, completion-notifying information indicating that the second data receiving apparatus has completed receiving the content data, after the content data has been received and the time has passed; and
said control unit is operable to change the state of the content data in said data transmitting apparatus to the unusable state after the completion-notifying information has been received.

3. The data transmitting apparatus according to claim 2, further comprising
a reproduction unit operable to reproduce the content data,
wherein: said calculation unit is operable to calculate a reproduction time required for said reproduction unit to complete reproduction of the content data;
said notification unit is operable to notify said reproduction unit of the time in the case where the time is shorter than the reproduction time; and
said reproduction unit is operable to indicate information on the time which has been notified by said notification unit.

4. The data transmitting apparatus according to claim 3,
wherein said reproduction unit is, in the case where the time is notified by said notification unit, operable to reproduce the content data at high speed so as to complete reproduction of the content data within the time.

5. The data transmitting apparatus according to claim 1,
wherein: said calculation unit is operable to calculate the time required for completing transmission of the content data to the second data receiving apparatus; and
said notification unit is operable: to notify the first data receiving apparatus of the time; and to cause the first data receiving apparatus to indicate information on the time.

6. The data transmitting apparatus according to claim 1, further comprising:
a control unit operable to change a state of the content data between a usable state and an unusable state; and
a selection unit operable to select, according to a specification by a user of said data transmitting apparatus, whether the time calculated by said calculation unit is a first time for the first data receiving apparatus or a second time for the second data receiving apparatus,
wherein, in the case where the first time is selected by said selection unit: said notification unit is operable: to notify the second data receiving apparatus of the first time; and to cause the second data receiving apparatus to transmit, to said data transmitting apparatus, completion-notifying information indicating that the second data receiving apparatus has completed receiving the content data, after the content data has been received and the first time has passed; and
said control unit is operable to change the state of the content data in said data transmitting apparatus to the unusable state, after the completion-notifying information has been transmitted; and
wherein, in the case where the second time is selected by said selection unit, said notification unit is operable: to notify the first data receiving apparatus of the second time; and to cause the first data receiving apparatus to indicate information on the second time.

7. The data transmitting apparatus according to claim 1,
wherein said transmitting unit is operable to transmit content data having use restriction under a copyright protection technology specification defined in the Digital Transmission Content Protection over IP (DTCP-IP).

8. The data transmitting apparatus according to claim 2,
wherein notification of the time and the completion-notifying information is performed by using a MV_FINALIZE command that is one of commands of the copyright protection technology specification defined in the DTCP-IP, and
said notification unit is operable to notify the time by replacing the time with a random number value which is one of parameters in the MV_FINALIZE command.

9. The data transmitting apparatus according to claims 2,
wherein said control unit is operable to change the state of the content data to the unusable state by deleting the content data.

10. A data receiving apparatus which receives, from a data transmitting apparatus, content data having use restriction so that the content data is transferred, said data receiving apparatus comprising:
a data receiving unit operable to receive the content data;
a time notification receiving unit operable to receive, from the data transmitting apparatus, a time required for the data transmitting apparatus to complete transmitting the content data to another data receiving apparatus;
a completion notification transmitting unit operable to transmit, to the data transmitting apparatus, completion-notifying information indicating that said data receiving unit has completed receiving the content data; and
a control unit operable to control said completion notification transmitting unit to transmit the completion-notifying information to the data transmitting apparatus after the content data has been received and the time has passed.

11. A data receiving apparatus which receives, for viewing, content data having use restriction, from a data transmitting apparatus, said data receiving apparatus comprising:
a data receiving unit operable to receive the content data;
a time notification receiving unit operable to receive, from the data transmitting apparatus, a time required for the data transmitting apparatus to complete transmitting the content data to another data receiving apparatus; and
an information indicating unit operable to indicate information on the time.

12. The data receiving apparatus according to claim 11, further comprising
a reproduction speed calculating unit operable to calculate a reproduction speed at which the content data is reproduced according to the time,
wherein said data receiving apparatus is operable to reproduce the content data at the reproduction speed by causing said data receiving unit to receive the content data in a receiving scheme changed so as to suit the reproduction speed calculated by said reproduction speed calculating unit.

13. A data transmitting and receiving system in which content data having use restriction is transmitted and received, said data transmitting and receiving system comprising:
a data transmitting apparatus;
a first data receiving apparatus; and
a second data receiving apparatus,
wherein: said data transmitting apparatus includes:
a transmitting unit operable: to transmit the content data to a first data receiving apparatus that receives the content data for viewing; and to transmit the content data to a second data receiving apparatus so that the content data is transferred;
a calculation unit operable to calculate a time required for said transmitting unit to complete transmitting the content data to said first data receiving apparatus;
a notification unit operable to notify said second data receiving apparatus of the time calculated by said calculation unit, said second data receiving apparatus being a data receiving apparatus that is not said first data receiving apparatus corresponding to the time; and
a control unit operable to change a state of the content data between a usable state and an unusable state and;
said first data receiving apparatus that receives content data for viewing includes:
a first data receiving unit operable to receive the content data; and
a display unit operable to display the content data received by said first data receiving unit; and
said second data receiving apparatus that receives content data so that the content data is transferred includes:
a second data receiving unit operable to receive the content data;
a time notification receiving unit operable to receive the time notified by said data transmitting apparatus;
a completion notification transmitting unit operable to transmit, to said data transmitting apparatus, completion-notifying information indicating that said second data receiving unit has completed receiving the content data; and
a completion notification control unit operable to control said completion notification transmitting unit to transmit the completion-notifying information to said data transmitting apparatus after the content data has been received and the time has passed, and
wherein, in said data transmitting apparatus, said control unit is operable to change the state of the content data in said data transmitting apparatus to the unusable state after the completion-notifying information has been transmitted.

14. A data transmitting and receiving system in which content data having use restriction is transmitted and received, said data transmitting and receiving system comprising:
a data transmitting apparatus;
a first data receiving apparatus; and
a second data receiving apparatus,
wherein: said data transmitting apparatus includes:
a transmitting unit operable: to transmit the content data to a first data receiving apparatus that receives the content data for viewing; and to transmit the content data to a second data receiving apparatus so that the content data is transferred;
a calculation unit operable to calculate a time required for said transmitting unit to complete transmitting the content data to said second data receiving apparatus;
a notification unit operable to notify said first data receiving apparatus of the time calculated by said calculation unit, said first data receiving apparatus being a data receiving apparatus that is not said second data receiving apparatus corresponding to the time; and
a control unit operable to change a state of the content data in said data transmitting apparatus between a usable state and an unusable state and;
said first data receiving apparatus that receives content data for viewing includes:
a first data receiving unit operable to receive the content data;
a time notification receiving unit operable to receive the time notified by said data transmitting apparatus; and
a indicating unit operable to indicate information on the time,
said second data receiving apparatus that receives content data so that the content data is transferred includes:
a second data receiving unit operable to receive the content data; and
a completion notification transmitting unit operable to transmit, to said data transmitting apparatus, completion-notifying information indicating that said second data receiving unit has completed receiving the content data; and
wherein, in said data transmitting apparatus, said control unit is operable to change the state of the content data in said data transmitting apparatus to the unusable state after the completion-notifying information has been received.

15. A data transmitting method used by a data transmitting apparatus which transmits content data having use restriction, said data transmitting method comprising:
transmitting the content data: to a first data receiving apparatus that receives the content data for viewing; and
transmitting the content data to a second data receiving apparatus so that the content data is transferred;
calculating a time required for said transmitting to complete transmitting the content data to one of the first data receiving apparatus and the second data receiving apparatus; and
notifying one of the first data receiving apparatus and the second data receiving apparatus of the time calculated in said calculating, the one of the first data receiving apparatus and the second data receiving apparatus being a data receiving apparatus not corresponding to the time.

16. A data receiving method used by a data receiving apparatus which receives, from a data transmitting apparatus, content data having use restriction so that the content data is transferred, said data receiving method comprising:
receiving the content data;
receiving a time from the data transmitting apparatus, the time being required for the data transmitting apparatus to complete transmitting the content data to another data receiving apparatus;
transmitting completion-notifying information to the data transmitting apparatus, the completion-notifying information indicating that the data receiving unit has completed receiving the content data; and
controlling said transmitting completion-notifying information so as to transmit the completion-notifying information to the data transmitting apparatus after the content data has been received and the time has passed.

17. A data receiving method used by a data receiving apparatus which receives, from a data transmitting apparatus, content data having use restriction for viewing, said data receiving method comprising:
receiving the content data;
receiving a time from the data transmitting apparatus, the time being required for the data transmitting apparatus to complete transmitting the content data to another data receiving apparatus; and
indicating information on the time.

18. A data transmitting program product for transmission of content data having use restriction by a data transmitting apparatus, said data transmitting program product, when loaded into a computer, allowing a computer to execute:
transmitting the content data: to a first data receiving apparatus that receives the content data for viewing; and transmitting the content data to a second data receiving apparatus so that the content data is transferred;
calculating a time required for said transmitting to complete transmitting the content data to one of the first data receiving apparatus and the second data receiving apparatus; and
notifying one of the first data receiving apparatus and the second data receiving apparatus of the time calculated in said calculating, the one of the first data receiving apparatus and the second data receiving apparatus being a data receiving apparatus not corresponding to the time.

19. A data receiving program product for a data receiving apparatus which receives, from a data transmitting apparatus, content data having use restriction so that the content data is transferred, said data receiving program product, when loaded into a computer, allowing a computer to execute:
receiving the content data;
receiving a time from the data transmitting apparatus, the time being required for the data transmitting apparatus to complete transmitting the content data to another data receiving apparatus;
transmitting completion-notifying information to the data transmitting apparatus, the completion-notifying information indicating that the data receiving unit has completed receiving the content data; and
controlling said transmitting completion-notifying information so as to transmit the completion-notifying information to the data transmitting apparatus after the content data has been received and the time has passed.

20. A data receiving program product for a data receiving apparatus which receives, from a data transmitting apparatus, content data having use restriction for viewing, said data receiving program product, when loaded into a computer, allowing a computer to execute:
receiving the content data;
receiving a time from the data transmitting apparatus, the time being required for the data transmitting apparatus to complete transmitting the content data to another data receiving apparatus; and
indicating information on the time.
